(19) United States
(12) Patent Application Publication
(10) Pub. No.: US 2010/0079420 A1
(43) Pub. Date: Apr. 1, 2010

(54) PIXEL DRIVE DEVICE, LUMINESCENCE DEVICE, AND METHOD OF CONNECTING CONNECTION UNIT IN PIXEL DRIVE DEVICE

(75) Inventors: Manabu Takei, Sagamihara-shi (JP); Tsuyoshi Ozaki, Tokyo (JP); Shunji Kashiyama, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd, Tokyo (JP)

(21) Appl. No.: 12/570,278

(22) Filed: Sep. 30, 2009

(30) Foreign Application Priority Data
Sep. 30, 2008 (JP) 2008-255550
Feb. 27, 2009 (JP) 2009-046147

(51) Int. Cl. G09G 5/00

(52) U.S. Cl. 345/204

(57) ABSTRACT

A pixel drive device that drives a pixel array including pixels connected to input/output terminals includes: a connection unit including connection terminals whose number is fewer than a number of the input/output terminals; and a connection switching unit that switches connection between the connection terminals and the input/output terminals. The input/output terminals of the pixel array are divided into a plurality of blocks each including a predetermined number of input/output terminals that is equal to/smaller than the number of connection terminals. The connection switching unit sequentially connects the connection terminals and the input/output terminals of each of the blocks, and sets the connection order of connecting the input/output terminals of each block to the connection terminals, such that adjoining two of the input/output terminals belonging to adjoining two of the blocks are connected to the same one of the connection terminals.

### BACKGROUND OF THE INVENTION

1. Field of the Invention

The present invention relates to a pixel drive device that drives a pixel array, a luminescence device that includes the pixel drive device, and a method of connecting a connection unit to the pixel array of the pixel drive device.

2. Description of the Related Art

An organic electroluminescence element (organic EL element) is an element formed of a fluorescent organic compound that emits light when an electric field is applied. Display devices having a display panel (pixel array) that is provided, in each of its pixels, with an organic light emitting diode (hereinafter, OLED) element formed of such an organic EL element have been drawing attention as the next-generation display devices.

The display panel of such display devices is formed of a matrix array of a plurality of pixels, for each of which an OLED element is provided. Luminescence of the OLED element of each pixel is controlled based on image data. In this manner, an image is displayed on the display panel.

An OLED element is a current-driven element that emits light at a luminance matching a current value of a current supplied thereto. An active matrix type display panel includes, in each of its pixels, one OLED element and a pixel drive circuit that includes a plurality of transistors, one of which is a drive transistor connected to the OLED element for making a drive current having a current value matching display data flow into the OLED element.

In one method of driving such a display panel, a drive signal that is a voltage signal having a voltage value matching display data is applied across the gate and source electrodes of the drive transistor, so that the voltage may be stored in a capacitive component between the gate and source electrodes and a drive current having a current value matching the stored voltage component may flow between the drain and source electrodes of the drive transistor to be supplied into the OLED element.

In this case, the current value of the drive current in the drive transistor depends on the current-voltage characteristic of the drain-source current with respect to the gate voltage. Therefore, if the drive transistors of the respective pixels have uneven electrical characteristics, the current values of the drive currents become uneven among the drive transistors.

Further, if the characteristic of the drive transistor of each pixel changes (deteriorates) due to drive hysteresis or the like, the current value of the drive current also fluctuates. Such unevenness and fluctuation of the current value of the drive current directly lead to degeneration of the image quality.

To improve the image quality, one existing method drives each pixel by applying a drive signal, which is set to a threshold voltage Vth, which is designated as the gate-source voltage of a drive transistor, across the gate and the source of the drive transistor to thereby suppress the influence of unevenness and fluctuation of the threshold voltage Vth.

However, when driving each pixel, this drive method requires a time period for setting the gate-source voltage of the drive transistor of the pixel to the threshold voltage Vth. A high-definition display panel including many pixels or a relatively large-sized display panel can only allow a relatively short time period for driving each pixel and is incompatible with this drive method.

Hence, a method that is currently being developed for driving such a display panel measures a corrective value for the threshold voltage Vth of the drive transistor of each pixel when turning on the device or at regular timings, stores the measured value, and in a display drive operation, corrects the drive signal by using the pre-stored corrective value.

Methods of measuring a corrective value include, for example, (i) a method of supplying a measurement current having a predetermined current value from each data line of the display panel to make the measurement current flow between the source and drain of the drive transistor of each pixel, measures the voltage value of a voltage dropped across each data line at that time, and obtains a corrective value based on the measured voltage value, and (ii) a method of supplying a measurement voltage having a predetermined voltage value from each data line of the display panel to make a current matching the measurement voltage flow between the source and drain of the drive transistor of each pixel, measures the current value of a current that flows through each data line at that time, and obtains a corrective value based on the measured current value.

However, in particular, a high-definition display panel including many pixels or a relatively large-sized display panel includes a huge number of data lines. Therefore, in a case where a driver is provided with only one measurement current source or voltage source such that a voltage value or current value as described above may be measured for each data line from one data line to another in a switching manner, these methods require a very long time period for the measurement and are not practical.

On the other hand, in a case where a driver is provided with the same number of measurement current sources or voltage sources as the number of the data lines such that voltage values or current values may be measured for all the data lines in parallel, the methods require a shorter time period for the measurement. However, the methods require a large number of current sources or voltage sources for the measurement, resulting in that the chip size of the driver becomes large or the driver consumes much electricity, leading to an increase of the product cost.

### SUMMARY OF THE INVENTION

The present invention is advantageous in that it can provide a pixel drive device, a luminescence device, and a method of connecting a connection unit in the pixel drive device that can allow corrective values for correcting drive signals to be obtained simultaneously from each predetermined number of data lines out of a plurality of data lines and hence can suppress increase of the produce cost as compared with a case where there are provided the same number of measuring devices as the number of data lines, and that can suppress influence on the obtained corrective values given by deviation of the characteristics of the measuring devices.

To achieve the above advantage, a pixel drive device according to a first aspect of the present invention drives a pixel array including a plurality of pixels connected to a plurality of input/output terminals, and includes: a connection unit that includes a plurality of connection terminals whose number is fewer than a number of the input/output terminals; and a connection switching unit that switches connection between the connection terminals and the input/output terminals, where the plurality of input/output terminals are divided into a plurality of blocks each including a predetermined number of input/output terminals, and the predetermined number is equal to or smaller than a number of the connection terminals, and the connection switching unit switches connection between the connection terminals and the input/output terminals in a manner that the connection terminals and the input/output terminals of each of the blocks are connected sequentially, while setting a connection order, in which the input/output terminals of each block are connected to the connection terminals, such that adjoining two of the input/output terminals that belong to adjoining two of the blocks are connected to the same one of the plurality of connection terminals.

To achieve the above advantage, a luminescence device according to a second aspect of the present invention includes: a pixel array that includes a plurality of pixels connected to a plurality of input/output terminals and each including a luminescence element; a connection unit that includes a plurality of connection terminals which are fewer than the plurality of input/output terminals; and a connection switching unit that switches connection between the connection terminals and the input/output terminals, where the plurality of input/output terminals are divided into a plurality of blocks each including a predetermined number of input/output terminals, the predetermined number is equal to or smaller than a number of the connection terminals, and the connection switching unit switches connection between the connection terminals and the input/output terminals in a manner that the connection terminals and the input/output terminals of each of the blocks are connected sequentially, while setting a connection order, in which the input/output terminals of each block are connected to the connection terminals, such that adjoining two of the input/output terminals that belong to adjoining two of the blocks are connected to the same one of the plurality of connection terminals.

To achieve the above advantage, a luminescence device according to a third aspect of the present invention includes: a pixel array including “m” input/output terminals D(i) (where i=1 to m, where “m” is a natural number), and a plurality of pixels connected to the input/output terminals D(i) and each including a luminescence element; a connection unit including “p” connection terminals P(k) (where k=1 to p, where “p” is a natural number and satisfies a relationship of p<m), and a connection switching unit that connects any of the input/output terminals D(i) of the pixel array and the connection terminal P(k) of the connection unit to each other, where the connection switching unit divides the input/output terminals D(i) of the pixel array into m/p blocks each including “p” input/output terminals out of the input/output terminals, and assigns a block number “b” to each divided block (where b=1 to m/p), where the connection switching unit is configured such that when it connects the input/output terminal D((b−1)×p+k) of an odd number block whose block number “b” is odd and the connection terminal P(k) of the connection unit to each other, it connects the input/output terminal D((b−1)×p+k) of an even number block whose block number “b” is even and the connection terminal P(p−k+1) of the connection unit to each other, and the connection switching unit is configured such that when it connects the input/output terminal D((b−1)×p+k) of an even number block whose block number “b” is even and the connection terminal P(k) of the connection unit to each other, it connects the input/output terminal D((b−1)×p+k) of an odd number block whose block number “b” is odd and the connection terminal P(p−k+1) of the connection unit to each other.

To achieve the above advantage, a method of connecting a connection unit in a pixel drive device according to a fourth aspect of the present invention is a method of connecting a connection unit to a pixel array of a pixel drive device that drives the pixel array, where the pixel array includes a plurality of pixels connected to a plurality of input/output terminals, and the connection unit includes a plurality of connection terminals whose number is fewer than a number of the input/output terminals. The method includes dividing the plurality of input/output terminals into a plurality of blocks each including a predetermined number of input/output terminals, the predetermined number being equal to or smaller than a number of the connection terminals, and performing a switching operation of sequentially switching connection between the connection terminals of the connection unit and the input/output terminals of each of the blocks, where the switching operation includes: when connecting the connection terminals and the input/output terminals of one of two adjoining blocks, connecting a specific one of the plurality of connection terminals to one of two adjoining input/output terminals belonging to one of the two adjoining blocks; and when connecting the connection terminals and the input/output terminals of the other of the two adjoining blocks, connecting the specific connection terminal to the other of the two adjoining input/output terminals belonging to the other of the two adjoining blocks.

### BRIEF DESCRIPTION OF THE DRAWINGS

These objects and other objects and advantages of the present invention will become more apparent upon reading of the following detailed description and the accompanying drawings in which:

FIG. 1 is a block diagram showing the configuration of a display device according to an embodiment of the present invention;

FIG. 2 is a circuit diagram showing the configuration of each pixel of the display device shown in FIG. 1;

FIG. 3 is a diagram showing the configuration of a system controller shown in FIG. 1;

FIG. 4 is a diagram showing the configuration of a data driver shown in FIG. 1;

FIG. 5 is a diagram showing the connection relationship between input/output terminals of a TFT panel and connection terminals of a current source unit, where a block number is odd;

FIG. 6 is a diagram showing the connection relationship between the input/output terminals of the TFT panel and the connection terminals of the current source unit, where a block number is even;

FIG. 7 is a flowchart showing a measuring process performed by the system controller shown in FIG. 1;

FIG. 8 is a diagram showing a specific connection relationship between the input/output terminals of a TFT panel and the connection terminals of the current source unit, where a block number is odd;

FIG. 9 is a diagram showing a specific connection relationship between the input/output terminals of a TFT panel and the connection terminals of the current source unit, where a block number is even;

FIG. 10 is a diagram showing connection lines between the input/output terminals of the TFT panel and the connection terminals of the current source unit and current characteristics, where FIG. 10(a) shows a connection line relationship between the input/output terminals of an odd number block of the TFT panel and the connection terminals of the current source unit, FIG. 10(b) shows a connection line relationship between the input/output terminals of an odd number block of the TFT panel and the connection terminals of the current source unit, FIG. 10(c) shows a connection line relationship between the input/output terminals of an odd number block of the TFT panel and the connection terminals of the current source unit, and FIGS. 10(d) to 10(f) show voltage characteristics that are observed when the connection line relationship is as shown in FIG. 10(a) to FIG. 10(c) respectively;

FIG. 11 is a diagram showing an example of a final voltage characteristic;

FIG. 12 is a block diagram showing a configuration of the display device, where the data driver includes two data drivers, as a first modification of the data driver;

FIG. 13 is a diagram showing an example of a voltage characteristic of the configuration shown in FIG. 12;

FIG. 14 is a diagram showing a configuration of the data driver, where the data driver includes a data driver main unit and a measuring unit, as a second modification of the data driver;

FIG. 15 is a diagram showing the data driver that is configured in accordance with a voltage application/current measurement method, as a third modification of the data driver;

FIG. 16 is a diagram showing a fourth modification of the data driver;

FIG. 17 is a diagram showing a fifth modification of the data driver;

FIG. 18 is a diagram showing a sixth modification of the data driver; and

FIG. 19 is a diagram showing a seventh modification of the data driver.

### DETAILED DESCRIPTION OF THE PREFERRED EMBODIMENT

A pixel drive device, a luminescence device including the pixel drive device, and a method of connecting a connection unit in the pixel drive device according to the present invention will be explained in detail with reference to an embodiment shown in the drawings. In the present embodiment, the luminescence explanation will be given on the premise that the luminescence device is a display device.

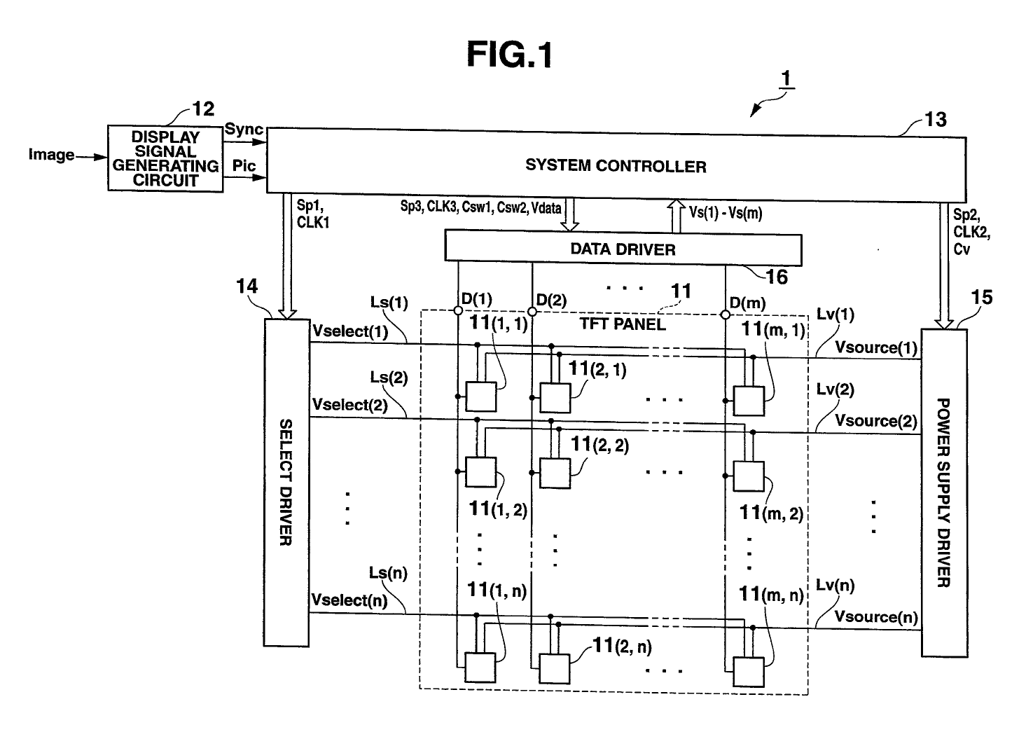

The configuration of the display device according to the present embodiment is shown in FIG. 1.

The display device (luminescence device) 1 according to the present embodiment includes a TFT panel (pixel array) 11, a display signal generating circuit 12, a system controller 13, a select driver 14, a power supply driver 15, and a data driver 16.

The TFT panel 11 includes a plurality of pixels 11(i, j) (where i=1 to m, and j=1 to n, where “m” and “n” are natural numbers).

The TFT panel 11 includes a plurality of data lines Ld(i) (where i=1 to m) disposed in a column direction, a plurality of select lines Ls(j) (where j=1 to n) disposed in a row direction, and a plurality of input/output terminals D(1) to D(m) provided for the respective columns as connected to one end of the respective data lines Ld(i) for connecting to the data driver 16.

Each pixel 11(i, j) corresponds to one pixel of an image. The pixels 11(i, j) are arranged in a matrix at the intersections of the data lines Ld(i) and the select lines Ls(j).

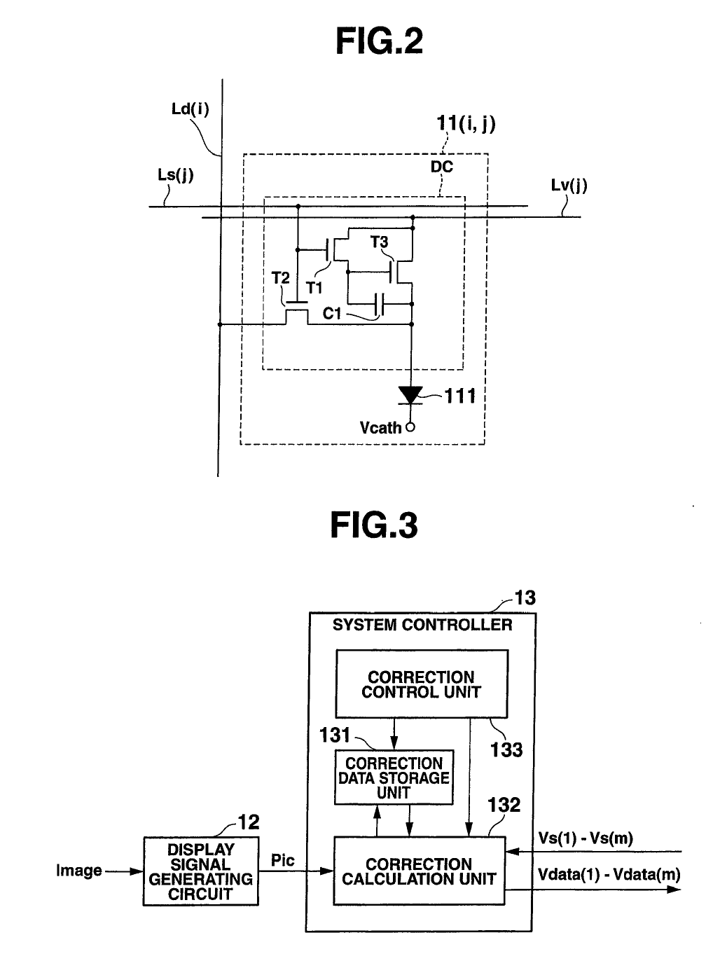

As shown in FIG. 2, each pixel 11(i, j) includes an organic EL element 111 as a luminescence element, transistors T1 to T3, and a capacitor C1. The transistors T1 to T3 and the capacitor C1 constitute a pixel drive circuit DC.

The organic EL element 111 is a display element that emits light by using a luminescence phenomenon caused by excitons generated by recombination of electrons and positive holes injected into an organic compound. The organic EL element 111 displays an image by emitting light at a luminance matching the current value of a current supplied thereto.

The organic EL element 111 includes a pixel electrode, above which a positive hole injecting layer, a luminescence layer, and an opposing electrode are formed. The positive hole injecting layer is formed above the pixel electrode, and has a function of supplying positive holes into the luminescence layer.

The pixel electrode is made of a light-transmissive conductive material such as Indium Tin Oxide (ITO), ZnO, etc. Each pixel electrode is insulated from the pixel electrodes of adjoining other pixels by an interlayer insulating film.

The positive hole injecting layer is made of an organic polymeric material that can inject and transport positive holes (holes). As an organic-compound-containing liquid that contains an organic polymeric hole injecting/transporting material, a PEDOT/PSS aqueous solution, which is a dispersed liquid prepared by dispersing polyethylenedioxythiophene (PEDOT) as a conductive polymer and polystyrene sulfonate (PSS) as a dopant in an aqueous solvent, is used.

The luminescence layer is formed above an interlayer. The luminescence layer has a function of emitting light when a predetermined voltage is applied across an anode electrode and a cathode electrode.

The luminescence layer is made of a luminescence material for red (R), green (G), or blue (B) that contains a known polymeric luminescence material that can emit fluorescent light or phosphorescent light, for example, a conjugated double-bond polymer of a polyparaphenylene vinylene series, a polyfluorene series, etc.

The luminescence material is dissolved (or dispersed) in an arbitrary one of an aqueous solvent and organic solvents of tetralin, tetramethylbenzene, mesitylene, xylene, etc. to be prepared as a solution (dispersed liquid). The luminescence layer is formed by coating the solution (dispersed liquid) by a nozzle coating method, an ink jetting method, or the like, and then volatilizing the solvent.

The opposing electrode has a dual-layered structure that includes: a layer that is made of a conductive material such as a low-work-function material such as Ca, Ba, etc.; and a light-reflective conductive layer made of Al or the like.

A current flows in the direction from the pixel electrode to the opposing electrode and not in the reverse direction, to make the pixel electrode and the opposing electrode function as an anode electrode and a cathode electrode respectively. A cathode voltage Vcath is applied to the cathode electrode.

The transistors T1 to T3 are TFTs constituted by n-channel-type Field Effect Transistors (FETs), and formed of, for example, amorphous silicon TFTs or polysilicon TFTs.

The transistor T3 is a drive transistor that supplies a current to the organic EL element 111. The drain or a current-positive-side end of the transistor T3 is connected to the voltage line Lv(j), and the source or a current-negative-side end of the transistor T3 is connected to the anode of the organic EL element 111. The transistor T3 supplies a current having a current value matching a control voltage, which is the gate-source voltage (hereinafter referred to as gate voltage for expediency) Vgs, to the organic EL element 111.

The transistor T1 is a switch transistor that connects or disconnects the gate and drain of the transistor T3 to or from each other.

The transistor T1 of each pixel 11(i, j) has its drain (terminal) connected to the voltage line Lv(j) (or to the drain of the transistor T3), and its source connected to the gate, or a control terminal of the transistor T3.

The gates (gate terminals) of the transistors T1 of the pixels 11(1, 1) to 11(m, 1) are connected to the select line Ls(1). Likewise, the gates of the transistors T1 of the pixels 11(1, 2) to 11(m, 2) are connected to the select line Ls(2), . . . , and the gates of the transistors T1 of the pixels 11(1, n) to 11(m, n) are connected to the select line Ls(n).

Taking the pixel 11(1, 1) for an example, when the select driver 14 outputs a signal of a Hi (High) level to the select line Ls(1), its transistor T1 is turned on. This connects the drain and gate of the transistor T3 to each other to make the transistor T3 enter into a diode-connected state.

When a signal of a Lo (Low) level is output to the select line Ls(1), the transistor T1 is turned off, and the transistor T2 is turned off. Even after the transistor T1 is turned off, the charges that have been charged in the capacitor C1 are retained.

The transistor T2 is a switch driver that is turned on or off as selected by the select driver 14 to make the power supply driver 15 and the data driver 16 electrically continuous or electrically discontinuous to or from each other.

The drain of the transistor T2 of each pixel 11(i, j) is connected to the anode (electrode) of the organic EL element 111.

The gates of the transistors T2 of the pixels 11(1, 1) to 11(m, 1) are connected to the select line Ls(1). Likewise, the gates of the transistors T2 of the pixels 11(1, 2) to 11(m, 2) are connected to the select line Ls(2), . . . , and the gates of the transistors T2 of the pixels 11(1, n) to 11(m, n) are connected to the select line Ls(n).

The sources, or the other terminals of the transistors T2 of the pixels 11(1, 1) to 11(1, n) are connected to the data line Ld(1). Likewise, the sources of the transistors T2 of the pixels 11(2, 1) to 11(2, n) are connected to the data line Ld(2), . . . and the sources of the transistors T2 of the pixels 11(m, 1) to 11(m, n) are connected to the data line Ld(m). The data lines Ld(1) to Ld(m) are connected to the input/output terminals D(1) to D(m) respectively.

Taking the pixel 11(1, 1) for an example, when the select driver 14 outputs a signal of the Hi level to the select line Ls(1), its transistor T2 is turned on to connect the anode of the organic EL element 111 and the data line Ld(1) to each other.

When a signal of the Lo level is output to the select line Ls(1), the transistor T2 is turned off to disconnect the anode of the organic EL element 111 and the data line Ld(1) from each other.

The capacitor C1 is a capacitive component that retains the gate voltage Vgs of the transistor T3. One end of the capacitor C1 is connected to the source of the transistor T1 and to the gate of the transistor T3, and the other end thereof is connected to the source of the transistor T3 and to the anode of the organic EL element 111.

When the transistor T3 is turned on to let a drain current Id flow from the voltage line Lv(j) to the drain of the transistor T2, the capacitor C1 is charged with the gate voltage Vgs having a value corresponding to the drain current Id and gets the charges of the voltage stored.

When the capacitors T1 and T2 are turned off, the capacitor 1 retains the gate voltage Vgs of the transistor T3.

Returning to FIG. 1, the display signal generating circuit 12 is supplied from the outside with an image signal Image such as a composite image signal or a component image signal, and acquires display data Pic such as a luminance signal, and a synchronization signal Sync from the supplied image signal Image. The display signal generating circuit 12 supplies the acquired display data Pic and synchronization signal Sync to the system controller 13.

The system controller 13 controls a correction process for the display data Pic, a writing process, and a luminescence operation of the organic EL element 111.

The correction process for the display data Pic is for correcting the display data Pic supplied by the display signal generating circuit 12 to produce a current output that matches the display characteristics. The writing process is for writing a voltage into the capacitor C1 of each pixel 11(i, j). The luminescence operation is for making the organic EL element 111 emit light.

To control the correction process for the display data Pic, the system controller 13 includes a correction data storage unit 131, a correction calculation unit 132, and a correction control unit 133, as shown in FIG. 3.

The correction data storage unit 131 stores the display data Pic supplied by the display signal generating circuit 12 and data about correction. When display data Pic is supplied by the display signal generating circuit 12 during a luminescence operation, the system controller 13 once stores the display data Pic for each pixel 11(i, j) in the correction data storage unit 131. In the correction process, the correction calculation unit 132 obtains β and a threshold voltage Vth for the transistor T3 of each pixel 11(i, j) as correction data, and stores them in the correction data storage unit 131.

Specifically, in the correction process, the correction calculation unit 132 is supplied by the data driver 16 with terminal potentials Vs(i) to Vs(m) of the input/output terminals D(1) to D(m) when the data driver 16 draws a current having a predetermined current value thereinto through the data lines Ld(i) to Ld(m). The correction calculation unit 132 calculates differential voltages Vdef(1) to Vdef(m) that represent the difference between the terminal potentials Vs(1) to Vs(m) of the input/output terminal D(1) to D(m) and the voltage of a signal Vsource(j). Each of the differential voltages Vdef(1) to Vdef(m) is roughly equal to an application voltage to be applied across the drain and source (=gate and source) of the transistor T3 of the corresponding one of the pixels on the selected row. The correction calculation unit 132 stores the calculated differential voltages Vdef(1) to Vdef(m) in the correction data storage unit 131. The correction calculation unit 132 obtains the threshold voltage Vth based on, for example, the current value of the drawn current and the value of the differential voltage corresponding to the application voltage to be applied to each pixel 11(i, j). The correction calculation unit 132 stores the obtained threshold voltage Vth in the correction data storage unit 131 as data about correction for each pixel 11(i, j).

When display data Pic is supplied by the display signal generating circuit 12 during a luminescence operation, the correction calculation unit 132 reads out the threshold voltages Vth from the correction data storage unit 131 for the respective pixels 11(i, j). The correction calculation unit 132 corrects the display data Pic based on the read-out threshold voltages Vth. The correction calculation unit 132 obtains voltage data Vdata, which are the display data Pic as corrected, and outputs them as voltage data Vdata(1) to Vdata(m) sequentially to the data driver 16.

The correction control unit 133 controls the correction process for the display data Pic. The system controller 13 reads out, row by row, the voltage data Vdata calculated by the correction calculation unit 132, and outputs them as Vdata(1) to Vdata(m) sequentially to the data driver 16.

The system controller 13 controls the writing process and the luminescence operation by performing such a correction process.

To perform such control, the system controller 13 generates clock signals CLK1, CLK3, and CLK3, start signals Sp1, Sp2, and Sp3, and various control signals and outputs them to the select driver 14, the power supply driver 15, and the data driver 16.

When an image signal Image is supplied from the outside, the system controller 13 synchronizes the clock signals CLK1 to CLK3, the start signals Sp1 to Sp3, and various control signals with the synchronization signal Sync supplied thereto by the display signal generating circuit 12.

The system controller 13 outputs the start signals Sp1 to Sp3 to the select driver 14, the power supply driver 15, and the data driver 16 as signals for activating them.

Returning to FIG. 1, the select driver 14 selects the rows of the TFT panel 11 sequentially. The select driver 14 is constituted by, for example, a shift register.

The select driver 14 is connected to the gates of the transistors T1 and T2 of each pixel 11(i, j) through the select line Ls(j) (where j=1 to n).

The select driver 14 starts when supplied by the system controller 13 with the start signal Sp1 that is synchronous with a vertical synchronization signal. In accordance with the clock signal CLK1 supplied by the system controller 13, the select driver 14 outputs a signal Vselect(j) of the Hi level to the pixels 11(1, 1) to 11(m, 1) of the first row, . . . , and to the pixels 11(1, n) to 11(m, n) of the n-th row sequentially. In this way, the select driver 14 selects the rows of the TFT panel 11 sequentially.

The power supply driver 15 outputs signals Vsource(1) to Vsource(n), each representing a voltage VL or a voltage VH, to the voltage line Lv(1) to Lv(n).

The power supply driver 15 is connected to the drain of the transistor T3 of each pixel 11(i, j) through the voltage line Lv(j) (where j=1 to n).

The power supply driver 15 starts when supplied by the system controller 13 with the start signal Sp2 that is synchronous with a vertical synchronization signal. The power supply driver 15 operates in accordance with the clock signal CLK2 supplied by the system controller 13.

The system controller 13 generates voltage control signals Cv(L) and Cv(H) as the control signals. The voltage control signals Cv(L) and Cv(H) control the voltage of the signals Vsource(1) to Vsource(n) to VL and VH.

In the present embodiment, the cathode voltage of the organic EL element 111 is set to 0V, and the voltage VL is set to the same potential as the cathode voltage Vcath=0V of the organic EL element 111. The voltage VH is set to, for example, +15V.

The system controller 13 supplies the voltage control signal Cv(L) to the power supply driver 15 in the correction process and in the writing process, and the voltage control signal Cv(H) thereto in the luminescence operation.

The data driver 16 writes voltage signals Sv(1) to Sv(m) that match the display data Pic into the capacitor C1 of the respective pixels 11(i, j) in the writing process.

In the correction process, the data driver 16 acquires the current value of a current that flows between the drain and source of the transistor T3 of each pixel 11(i, j) and the value of the terminal potential Vs(i) of each input/output terminal D(i), which terminal potential Vs(i) corresponds to the application voltage to be applied across the drain and source (=gate and source) of the transistor T3, as data based on which the threshold voltage is obtained.

The data driver 16 according to the present embodiment acquires the current and voltage values in accordance with a current supply/voltage measurement method.

In accordance with the current supply/voltage measurement method, a current is drawn from the pixels 11(i, j) through the data lines Ld(i) and via the input/output terminals D(1) to D(m), and the terminal voltages Vs(1) to Vs(m) of the input/output terminals D(1) to D(m) corresponding to the pixels 11(1, j) to 11(m, j) are measured row by row.

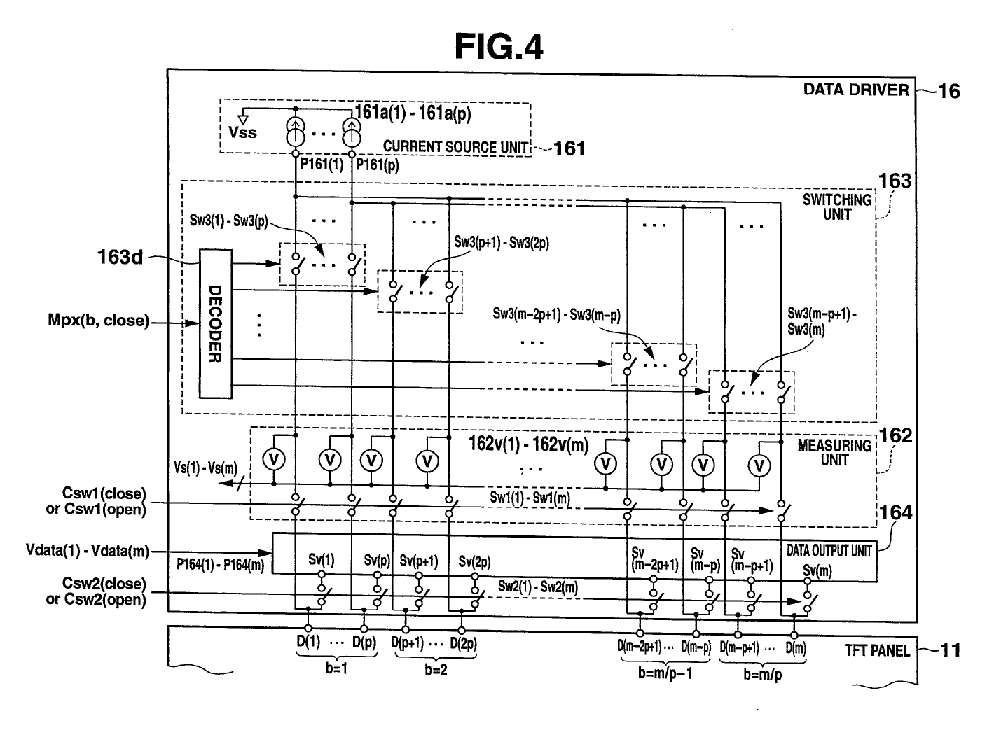

Specifically, the data driver 16 includes a current source unit 161, a measuring unit 162, a switching unit 163, switches Sw1(i) and Sw2(i), and a data output unit 164, as shown in FIG. 4.

The current source unit 161 includes a plurality of current sources 161a(1) to 161a(p) that correspond to the data lines Ld(1) to Ld(p) respectively. The current source 161a(k) (where k=1 to p) draws a constant current having a preset current value from each input/output terminal D(i) of the TFT panel 11. The current source unit 161 is a connection unit.

The current source unit 161 has a “p” connection terminals P161(1) to P161(p) (where “p” is a natural number). The number “p” of current sources 161a(k) (where k=1 to p) is a number obtained by dividing the number “m” of columns on the TFT panel 11 by some number, in order not to make the chip size of the data driver 16 large. A current-positive-side end of the current source 161a(k) is connected to the connection terminal P161(k). A voltage Vss is applied to a current-negative-side end of the current source 161a(k). In the present embodiment, the voltage Vss is set to the same potential as the cathode voltage Vcath (=0V) of the organic EL element 111.

The measuring unit 162 includes voltmeters 162v(1) to 162v(m) and switches Sw1(1) to Sw1(m). The number of voltmeters 162v(i) and the number of switches Sw1(i) are the same as the number “m” of columns on the TFT panel 11.

The voltmeters 162v(i) (where i=1 to m) measure the terminal potentials Vs(1) to Vs(m) of the input/output terminals D(i) to D(m) respectively. One end of each voltmeter 162v(i) is connected to a current-negative-side terminal of the switch Sw1(i).

The voltmeter 162v(i) is constituted by, for example, an analog-digital converter (ADC). The voltmeter 162v(i) measures an analog potential of the input/output terminal D(i), converts it into a digital terminal potential Vs(i), and outputs it to the system controller 13.

The switches Sw1(1) to Sw1(m) connect or disconnect the input/output terminals D(1) to D(m) of the TFT panel 11 and the measuring unit 162 to or from each other, during the measurement of the terminal potentials Vs(1) to Vs(m) of the input/output terminals D(1) to D(m).

A current-positive-side terminal of the switch Sw1(i) (where i=1 to m) is connected to the input/output terminal D(i) of the TFT panel 11.

The system controller 13 generates a switch control signal Csw1(close) or Csw1(open) as a control signal, supplies the switch control signal Csw1(close) or Csw1(open) to the data driver 16 to close or open the switch Sw1(i).

The switches Sw1(i) are closed when supplied by the system controller 13 with the switch control signal Csw1(close). When the switches Sw1(i) are closed, the input/output terminals D(1) to D(m) of the TFT panel 11 and the voltmeters 162v(1) to 162v(m) are connected to each other.

The switches Sw(i) are opened when supplied by the system controller 13 with the switch control signal Csw1(open). When the switches Sw1(i) are opened, the input/output terminals D(1) to D(m) of the TFT panel 11 and the voltmeters 162v(1) to 162v(m) are disconnected from each other.

The switches Sw2(1) to Sw2(m) connect or disconnect output terminals P164(1) to P164(m) of the data output unit 164 and the input/output terminals D(1) to D(m) of the TFT panel 11 to or from each other. The number of switches Sw2(i) is the same as the number “m” of columns on the TFT panel 11.

Signal-output-side terminals of the switches Sw2(1) to Sw2(m) are connected to the output terminals P164(1) to P164(m) of the data output unit 164 respectively, and panel-side terminals of the switches Sw2(1) to Sw2(m) are connected to the input/output terminals D(1) to D(m) respectively.

The system controller 13 generates a switch control signal Csw2(close) or Csw2(open) as a horizontal control signal, and supplies the switch control signal Csw2(close) or Csw2(open) to the data driver 16 to control closing or opening of the switches Sw2(i) (where i=1 to m).

The switches Sw2(i) are closed when supplied by the system controller 13 with the switch control signal Csw2(close). When the switches Sw2(i) are closed, the output terminals P164(i) of the data output unit 164 and the input/output terminals D(i) are connected to each other.

The switches Sw2(i) are opened when supplied by the system controller 13 with the switch control signal Csw2(open). When the switches Sw2(i) are opened, the output terminals P164(i) of the data output unit 164 and the input/output terminals D(i) are disconnected from each other.

The input/output terminals D(1) to D(m) are divided into B (=m/p) blocks, each including “p” input/output terminals corresponding to the “p” connection terminals P161(k) of the current source unit 161. The number B is the total number of blocks.

The switching unit 163 connects the input/output terminals of one block to the connection terminals P161(1) to P161(p) of the current source unit 161 and then connects the input/output terminals of another block thereto by block-by-block switching among the input/output terminals D(1) to D(m) of the TFT panel 11. As shown in FIG. 4, the blocks are assigned block numbers “b” (where b=1 to m/p) in the order from those closer to the input/output terminal D(1).

In FIG. 4, the switching unit 163 is configured to connect each input/output terminal D((b−1)×p+k) of an odd number block having an odd block number “b” to the connection terminal P161(k) of the current source unit 161, and to connect each input/output terminal D((b−1)×p+k) of an even number block having an even block number “b” to the connection terminal P161(p−k+1) of the current source unit 161.

The configuration of the switching unit 163 is not limited to the one shown in FIG. 4. The switching unit 163 may be configured to connect each input/output terminal D((b−1)×p+k) of an even number block having an even block number “b” to the connection terminal P161(k) of the current source unit 161, and to connect each input/output terminal D((b−1)×p+k) of an odd number block having an odd block number “b” to the connection terminal P161(p−k+1) of the current source unit 161.

To achieve this connection, the switching unit 163 includes switches Sw3(1) to Sw3(m), and a decoder 163d.

The switches Sw3(1) to Sw3(m) connect or disconnect the “p” input/output terminals of any block, among the input/output terminals D(1) to D(m) of the TFT panels 11, and the connection terminals P161(1) to P161(p) of the current source unit 161 to or from each other.

A current-positive-side terminal (one end) of each of the switches Sw3(1) to Sw3(m) is connected to the current-negative-side terminal of a corresponding one of the switches Sw1(1) to Sw1(m).

A current-negative-side terminal (the other end) of each of the switches Sw3(1) to Sw3(p), . . . , or each of the switches Sw3(m−2p+1) to Sw3(m−p) is connected to a corresponding one of the connection terminals P161(1) to P161(p) of the current source unit 161.

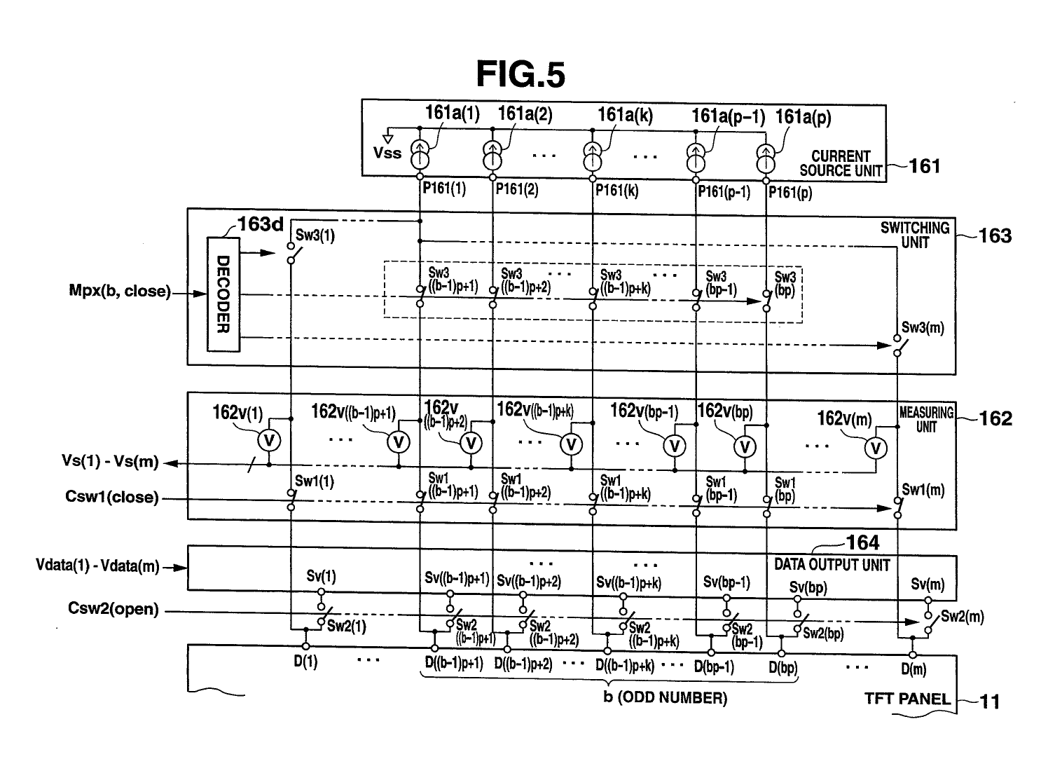

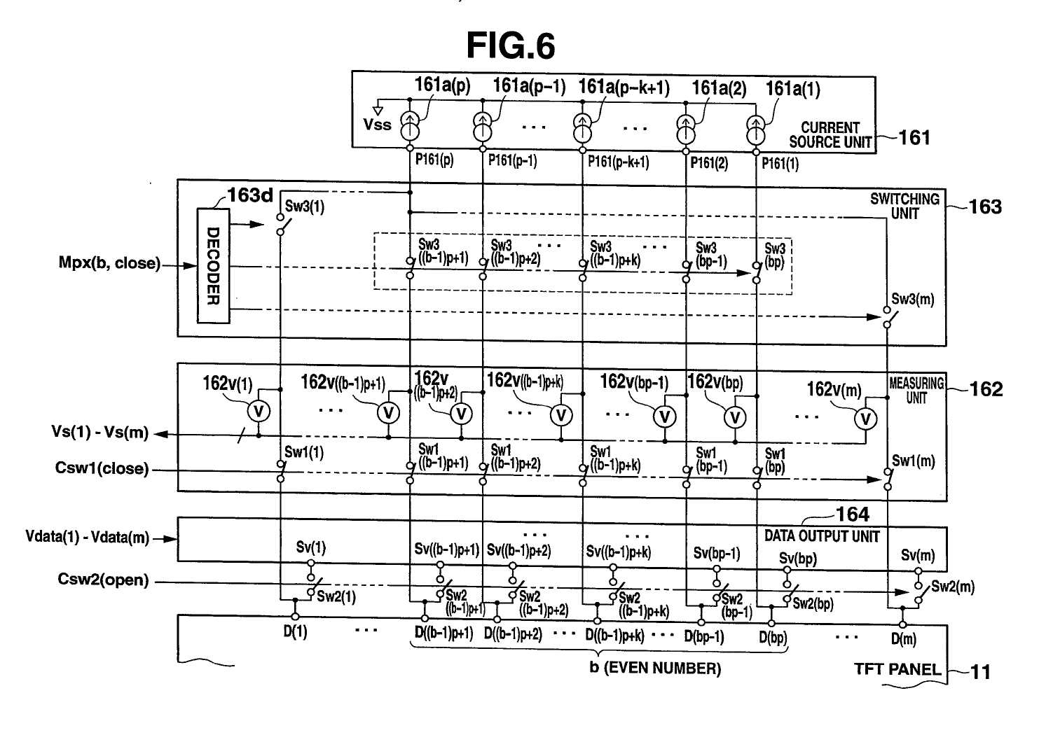

FIG. 5 shows the connection relationship between the input/output terminals of the TFT panel and the connection terminals of the current source unit, where the block number “b” is odd. FIG. 6 shows the connection relationship between the input/output terminals of the TFT panel and the connection terminals of the current source unit, where the block number “b” is even.

As shown in FIG. 5, when the switches Sw1(1) to Sw1(m) are closed, the current-positive-side terminal of each of the switches Sw3(1) to Sw(p), . . . , or each of the switches Sw3(m−2p+1) to Sw3(m−p) is connected to the input/output terminal D((b−1)×p+k) of a corresponding one of odd number blocks having odd block numbers “b” of the TFT panel 11.

That is, when the block number “b” is odd, each of the switches Sw3(1) to Sw3(p), . . . , or each of the switches Sw3(m−2p+1) to Sw3(m−p) connects the input/output terminal D((b−1)×p+k) of the TFT panel 11 and the connection terminal P161(k) of the current source unit 161 to each other. This connection order will be referred to as normal order.

A current-negative-side terminal (the other end) of each of the switches Sw3(p+1) to Sw3(2p), . . . , or each of the switches Sw3(m−p+1) to Sw3(m) is connected to a corresponding one of the connection terminals P161(1) to P161(p) of the current source unit 161.

As shown in FIG. 6, when the switches Sw1(1) to Sw1(m) are closed, the current-positive-side terminal of each of the switches Sw3(p+1) to Sw3(2p), . . . , or each of the switches Sw3(m−p+1) to Sw3(m) is connected to the input/output terminal D((b−1)×p+k) of a corresponding one of even number blocks having even block numbers “b” of the TFT panel 11.

That is, when the block number “b” is even, each of the switches Sw3(p+1) to Sw3(2p), . . . , or each of the switches Sw3(m−p+1) to Sw3(m) connects the input/output terminal D((b−1)×p+k) of the TFT panel 11 and the connection terminal P161(p−k+1) of the current source unit 161 to each other. This connection order will be referred to as reverse order.

The decoder 163d controls opening and closing of the switches Sw3(1) to Sw3(m). When supplied by the system controller 13 with a switch control signal Mpx(b, close), the decoder 163d decodes the supplied switch control signal Mpx(b, close) to control the switches Sw3(1) to Sw3(m) accordingly.

When supplied by the system controller 13 with a switch control signal Mpx(b, close), the decoder 163d decodes the signal, and closes the switches Sw3((b−1)×p+1) to Sw3(bp) while opening the other switches Sw3.

With this configuration of the switching unit 163, deviation (current deviation), if any, of the current values of the currents output by the current sources 161a(1) to 161a(p) will produce no block difference among the results of measurement by the respective voltmeters 162v(1) to 162v(m) of the measuring unit 162.

The data output unit 164 outputs a voltage signal Sv(i) representing an analog voltage that matches voltage data Vdata(i) to the TFT panel 11 in the writing process.

The data output unit 164 includes, for example, a digital-analog converter (DAC), and converts digital voltage data Vdata(i) (where i=1 to m) supplied by the system controller 13 to analog voltage signals Sv(i).

When the switches Sw2(1) to Sw2(m) are closed, the voltage signals Sv(i) that are output by the data output unit 164 are output to the input/output terminals D(1) to D(m) of the TFT panel 11 respectively.

Next, an operation of the display device 1 according to the present embodiment will be explained.

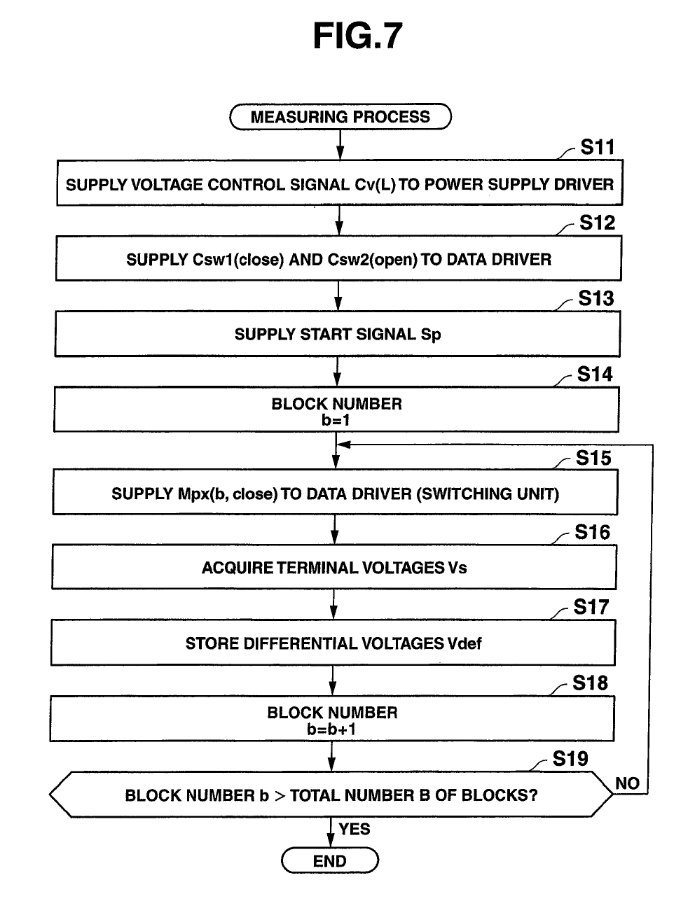

The system controller 13 performs the measuring process by the measuring unit 162 at a given timing such as, for example, when the display device 1 is activated for actual use or regular timings, etc. The system controller 13 performs the measuring process in accordance with the flowchart shown in FIG. 7.

First, the system controller 13 supplies the voltage control signal Cv(L) to the power supply driver 15 (step S11).

The system controller 13 supplies the switch control signals Csw1(close) and Csw2(open) to the data driver 16 (step S12).

The system controller 13 supplies the start signals Sp1 to Sp3 to the select driver 14, the power supply driver 15, and the data driver 16 (step S13).

The system controller 13 sets “1” as the block number “b” of a block that the system controller 13 intends to designate by the switch control signal Mpx(b, close) (step S14).

The system controller 13 supplies the switch control signals Mpx(b, close) and Mpx(bx, open) to the data driver 16 (switching unit 163) (step S15).

The system controller 13 acquires the terminal potentials Vs(1) to Vs(p) measured by the voltmeters 162v(1) to 162v(p) (step S16).

The correction calculation unit 132 obtains the differential voltages Vdef(1) to Vdef(p) based on the acquired terminal potentials Vs(1) to Vs(p), and stores them in the correction data storage unit 131 (step S17).

The system controller 13 increments the block number “b” in the switch control signal Mpx(b, close) by +1 (step S18).

The system controller 13 determines whether or not the block number “b” has exceeded the total number B of blocks (step S19).

In a case where it is determined that the block number “b” has not exceeded the total number B of blocks (step S19; No), the system controller 13 performs steps S15 to S18 again.

In a case where it is determined that the block number “b” has exceeded the total number B of blocks (step S19; Yes), the system controller 13 terminates the measuring process.

Next, a specific operation of the system controller 13 when performing this measuring process will be explained.

Here, it is assumed that the number “m” (the number of terminals of the TFT panel 11) is 576, and the number “p” (the number of terminals of the current source unit 161) is 96. In this case, the total number B of blocks is 6 (˜576/96).

First, the system controller 13 supplies the voltage control signal Cv(L) to the power supply driver 15 (the procedure at step S11). In response, the power supply driver 15 outputs the signals Vsource(1) to Vsource (n), each representing the voltage VL, to the voltage lines Lv(1) to Lv(n) respectively.

The select driver 14, the power supply driver 15, and the data driver 16 start up when supplied by the system controller 13 with the start signals Sp1 to Sp3, and operate in accordance with the clock signals CLK1 to CLK3.

The select driver 14 outputs the signal Vselect(1) of the Hi level to the select line Ls(1) to select the pixels 11(1, 1) to 11(576, 1) of the first row.

The transistors T1 and T2 of each of the pixels 11(1, 1) to 11(576, 1) are turned on with the signal Vselect(1) of the Hi level supplied to their gates, and the transistor T3 of each of these pixels enters into the diode-connected state.

Then, the system controller 13 supplies the switch control signal Mpx(1, close) to the data driver 16 (the procedure at step S15). In response, the decoder 163d decodes the switch control signal Mpx(1, close), thereby closing the switches Sw3(1) to Sw3(96) corresponding to the block having the block number “b”=1 and opening the other switches Sw3(97) to Sw3(576).

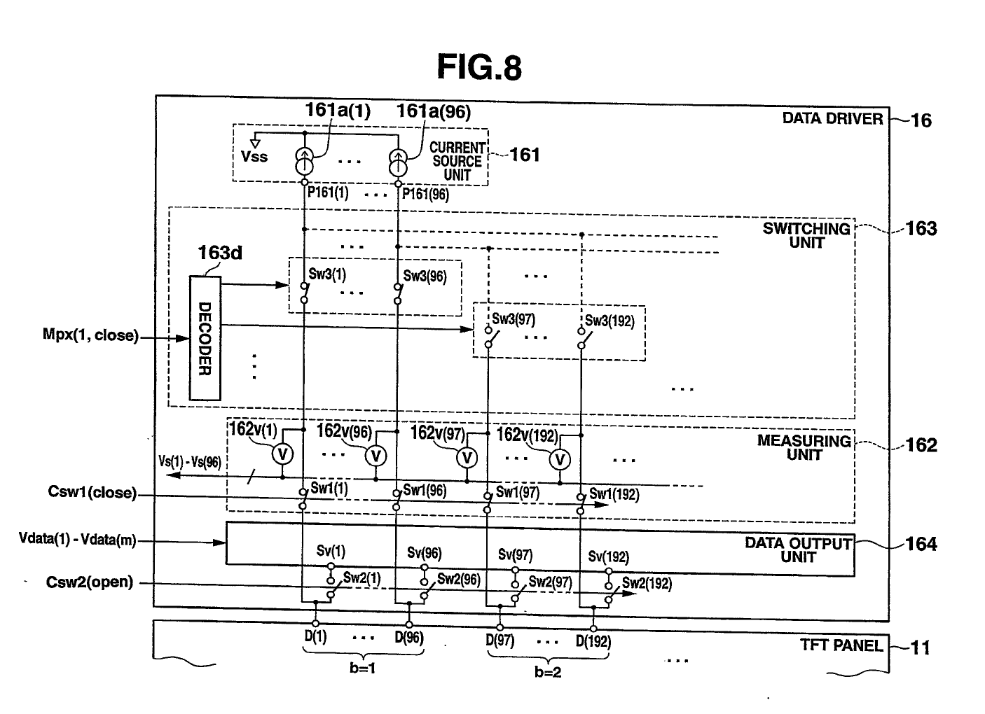

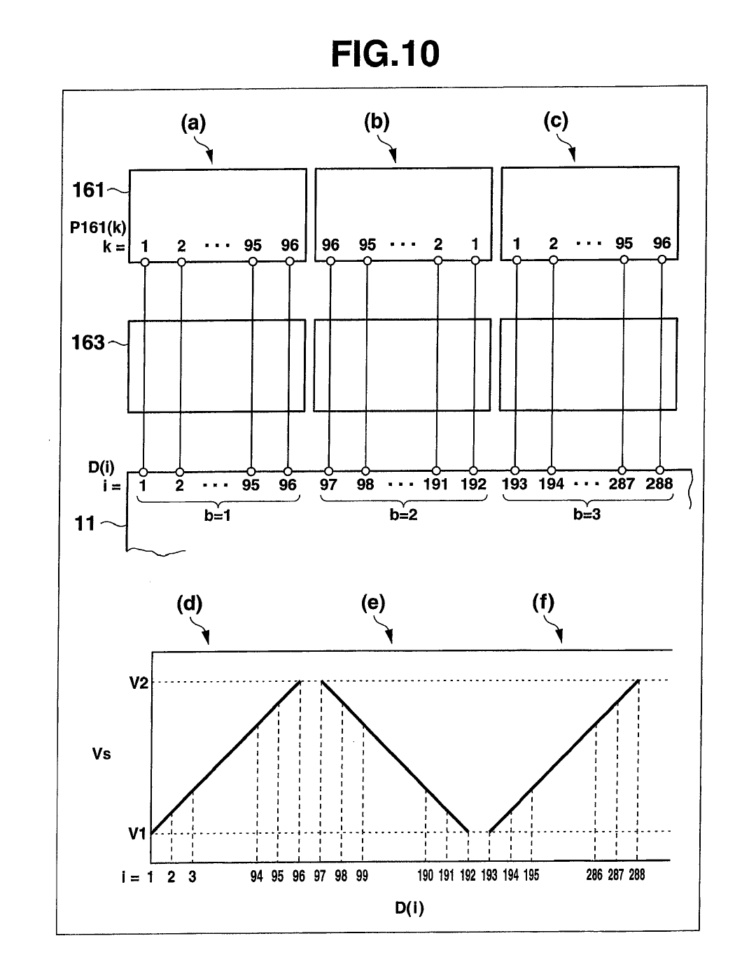

In this case, as the designated block number “b” is 1, which is odd, the opening/closing control by the decoder 163d on the switches Sw3(1) to Sw3(576) results in the connection configuration shown in FIG. 5.

Where b=1 and p=96, the input/output terminals D(1) to D(96) and the connection terminals P161(1) to P161(96) are connected to each other via the switches Sw3(1) to Sw3(96) respectively as shown in FIG. 8, being connected in the normal order as shown in FIG. 10(a).

When the input/output terminals D(1) to D(96) and the connection terminals P161(1) to P161(96) are connected to each other respectively, the current sources 161a(1) to 161a(96) draw the constant current from the input/output terminals D(1) to D(96) respectively.

The current flows from the power supply driver 15 to the voltage source for the voltage Vss via the drain and source of the transistor T3 in the diode-connected state and the transistor T2 of each of the pixels 11(1, 1) to 11(96, 1), each of the data lines Ld(1) to Ld(96), each of the input/output terminals D(1) to D(96) of the TFT panel 11, and each of the current sources 161a(1) to 161a(96).

The voltmeters 162v(1) to 162v(96) of the measuring unit 162 measure the terminal potentials Vs(1) to Vs(96) of the input/output terminals D(1) to D(96) respectively, and output them to the system controller 13 sequentially.

The correction calculation unit 132 calculates the differential voltages Vdef(1) to Vdef(96) based on the terminal potentials Vs(1) to Vs(96) output by the data driver 16. The correction calculation unit 132 stores the calculated differential voltages Vdef(1) to Vdef(96) in the correction data storage unit 131 as voltages corresponding to the voltages to be applied across the drain and source (=gate and source) of the transistor T3 of the pixels 11(1, 1) to 11(96, 1) (the procedure at step S17).

Next, the system controller 13 supplies the switch control signal Mpx(2, close) to the data driver 16 (the procedure at step S15). In response, the decoder 163d decodes the switch control signal Mpx(2, close) to thereby close the switches Sw3(97) to Sw3(192) corresponding to the block having the block number “b”=2 and open the other switches Sw3(1) to Sw3(96), and Sw3(193) to Sw3(576).

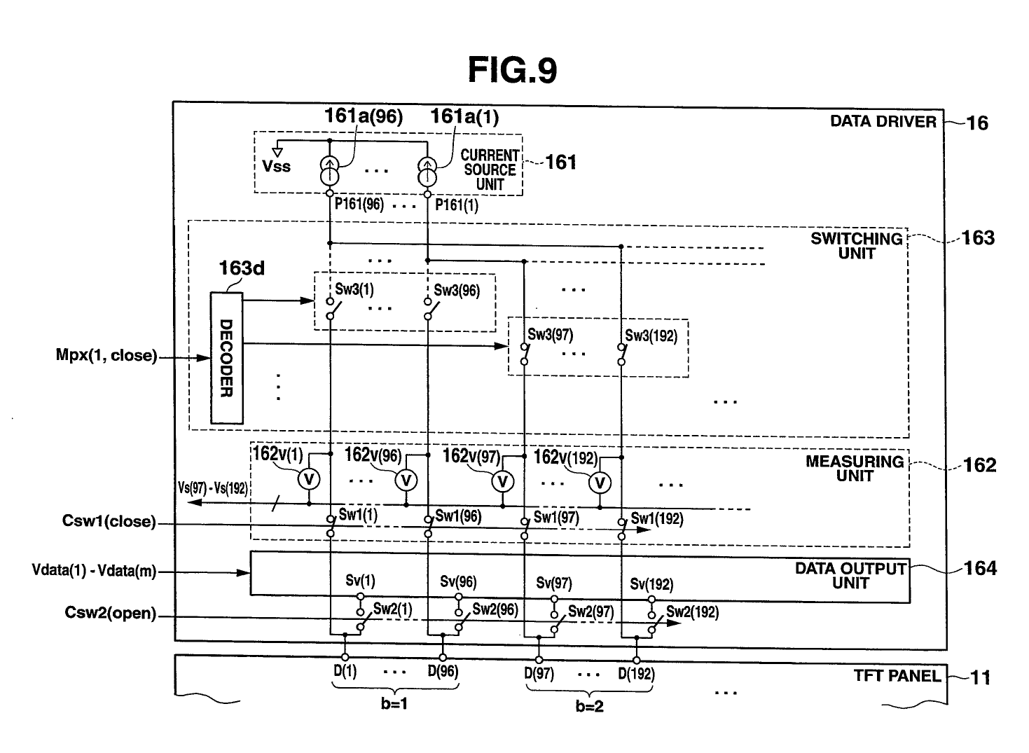

In this case, as the designated block number “b” is 2, which is even, the opening/closing control by the decoder 163d on the switches Sw3(1) to Sw3(576) results in the connection configuration shown in FIG. 6.

Where b=2 and p=96, the input/output terminals D(97) to D(192) and the connection terminals P161(96) to P161(1) are connected to each other via the switches Sw3(97) to Sw3(192) respectively as shown in FIG. 9, being connected in the reverse order as shown in FIG. 10(b).

When the input/output terminals D(97) to D(192) and the connection terminals P161(96) to P161(1) are connected to each other respectively, the current sources 161a(96) to 161a(1) draw the constant current from the input/output terminals D(97) to D(192) respectively.

The current flows from the power supply driver 15 to the voltage source for a negative voltage Vss via the drain and source of the transistor T3 and the transistor T2 of each of the pixels 11(97, 1) to 11(192, 1), each of the data lines Ld(97) to Ld(192), each of the input/output terminals D(97) to D(192) of the TFT panel 11, and each of the current sources 161a(96) to 161a(1).

The voltmeters 162v(97) to 162v(192) of the measuring unit 162 measure the terminal potentials Vs(97) to Vs(192) of the input/output terminals D(97) to D(192) respectively, and output them to the system controller 13 sequentially.

The correction calculation unit 132 calculates the differential voltages Vdef(97) to Vdef(192) based on the terminal potentials Vs(97) to Vs(192) output by the data driver 16. The correction calculation unit 132 stores the calculated differential voltages Vdef(97) to Vdef(192) in the correction data storage unit 131 as voltages corresponding to the voltages to be applied across the drain and source (=gate and source) of the transistor T3 of the pixels 11(97, 1) to 11(192, 1) (the procedure at step S17).

Next, the system controller 13 supplies the switch control signal Mpx(3, close) to the decoder 163d (the procedure at step S15). In response, the decoder 163d decodes the switch control signal Mpx(3, close) to thereby close the switches Sw3(193) to Sw3(288) and open the other switches Sw3(1) to Sw3(192), and Sw3(289) to Sw3(576).

In this case, as the designated block number “b” is 3, which is odd, the opening/closing control by the decoder 163d on the switches Sw3(1) to Sw3(576) results in the connection configuration shown in FIG. 5.

Where b=3 and p=96, the input/output terminals D(193) to D(288) and the connection terminals P161(1) to P161(96) are connected to each other via the switches Sw3(193) to Sw3(288) respectively, being connected in the normal order as shown in FIG. 10(c).

When the input/output terminals D(193) to D(288) and the connection terminals P161(1) to P161(96) are connected to each other respectively, the current sources 161a(1) to 161a(96) draw the constant current from the input/output terminals D(193) to D(288) respectively.

As the connection order is the normal order as shown in FIG. 10(c), when the current sources 161a(1) to 161a(96) of the current source unit 161 drawn the constant current, the current flows from the power supply driver 15 to the voltage source for a negative voltage Vss via the drain and source of the transistor T3 and the transistor T2 of each of the pixels 11(193, 1) to 11(288, 1), each of the input/output terminals D(193) to D(288) of the TFT panel 11, and each of the current sources 161a(1) to 161a(96).

The voltmeters 162v(193) to 162v(288) of the measuring unit 162 measure the terminal potentials Vs(193) to Vs(288) of the source input/output terminals D(193) to D(288) of the transistors T3 of the pixels 11(193, 1) to 11(288, 1) respectively, and output them to the system controller 13 sequentially.

The correction calculation unit 132 calculates the differential voltages Vdef(193) to Vdef(288) based on the terminal potentials Vs(193) to Vs(288) output by the data driver 16. The correction calculation unit 132 stores the calculated differential voltages Vdef(193) to Vdef(288) in the correction data storage unit 131 as voltages corresponding to the voltages to be applied across the drain and source (=gate and source) of the transistor T3 of the pixels 11(193, 1) to 11(288, 1) (the procedure at step S17).

The system controller 13 performs this process six times in total for the first row (procedures at steps S15 to S19).

Hence, the differential voltages Vdef(1) to Vdef(576) are stored in the correction data storage unit 131 as the voltages corresponding to the voltages to be applied across the drain and source (=gate and source) of the transistor T3 of the pixels 11(1, 1) to 11(576, 1) of the first row.

Then, the correction calculation unit 132 reads out the differential voltages Vdef(i) corresponding to the pixels 11(i, j) from the correction data storage unit 131 row by row, obtains the threshold voltage for the transistor T3 of the respective pixels 11(i, j) based on the read-out differential voltages Vdef(i), and stores the threshold voltage in the correction data storage unit 131.

The effects achieved by the configuration of the present invention will now be explained.

In a case where, similarly to the present embodiment, the number of current sources provided on a data driver is 1/q of the number “m” of columns on a TFT panel, i.e., the number of current sources is m/q, such that measurement of voltage values from all the data lines is performed in a manner that each m/q data lines are grouped together and connected group by group sequentially to the group of m/q current sources, it is possible to suppress increase of the measurement time and increase of the cost to some extent.

However, even if the current values of the currents to be output by the respective ones of this group of m/q current sources are set to the same value, it is normally hard to make the current values of all the currents to be actually output by the respective current sources the same. The current values of the currents output by the current sources have some deviation (unevenness).

Accordingly, the voltage values to be measured with the use of this group of current sources will be influenced by this deviation. Further, in the case where voltage values are measured from each of the respective groups of m/q data lines, which are sequentially connected to the group of current sources, the influence of the deviation might occur cyclically, and the values measured from adjoining data lines that are on the boundary of connection switching might have gray-level discontinuity between them due to the deviation.

Display data will be corrected based on the values measured in this manner, and the TFT panel will be driven based on this corrected display data. Therefore, if the measured values have gray-level discontinuity, the values in the display data to be corrected based on such discontinuous values will also have gray-level discontinuity. As a result, a displayed image will have a low image quality, with vertical strips appearing on it.

As compared with this, the configuration of the present embodiment can prevent such a gray-level discontinuity between the values to be measured from adjoining data lines on the boundary of connection switching, and hence prevent degradation of the display quality that might be caused due to connection switching.

A specific explanation will now be given. First, assume that the transistors T1 to T3 of all the pixels 11(1, 1) to 11(576, 1) of the first row have the same characteristic.

On this premise, assume that, where the connection order is the normal order as shown in FIG. 10(a), the terminal potentials Vs(1) to Vs(96) of the input/output terminals D(1) to D(96) that are measured by the voltmeters 162v(1) to 162v(96) have a characteristic of changing from V1 to V2 as the data line numbers ascend from 1 to 96 as shown in FIG. 10(d), due to the deviation of the characteristics of the current sources 161a(1) to 161a(96) of the current source unit 161.

In this case, when the connection order is turned to the reverse order as show in FIG. 10(b), the change of the terminal potentials Vs(97) to Vs(192) of the input/output terminals D(97) to D(192) measured by the voltmeters 162v(97) to 162v(192) as the data line numbers ascend from 97 to 192 will be the reversed version of FIG. 10(d) where the data line numbers descend. Therefore, this change is from V2 to V1 as shown in FIG. 10(e).

Then, when the connection order is turned to the normal order as shown in FIG. 10(c), the terminal potentials Vs(193) to Vs(288) of the input/output terminals D(193) to D(288) measured by the voltmeters 162v(193) to 162v(288) will have the same changing characteristic as that shown in FIG. 10(d), which is the change from V1 to V2 as shown in FIG. 10(f).

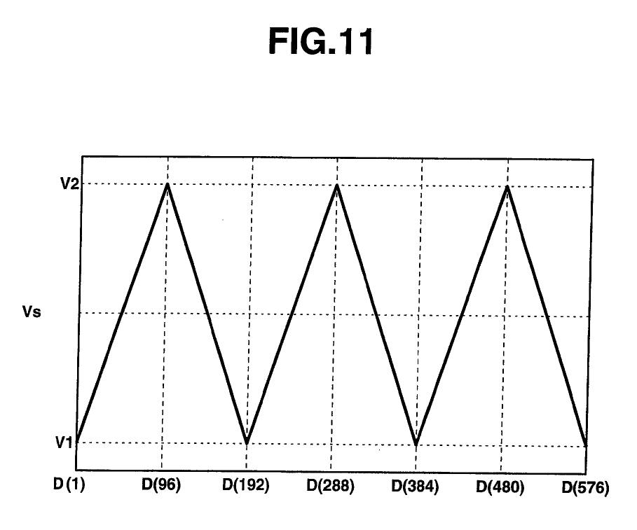

Hence, where the input/output terminals D(1) to D(576) of the TFT panels 11 and the connection terminals P161(1) to P161(96) of the current source unit 161 are connected in the normal order and the reverse order alternately block by block, the potential terminals Vs(1) to Vs(576) of the input/output terminals D(1) to D(576) will show such a characteristic as shown in FIG. 11.

As can be understood, in accordance with the configuration of the present embodiment, even if the terminal potentials Vs(1) to Vs(p) vary from V1 to V2 due to the deviation of the characteristics of the current sources 161a(1) to 161a(p), the terminal potentials Vs of specific input/output terminals among the terminal potentials Vs(1) to Vs(m) of the input/output terminals D(1) to D(m), i.e., the terminal potentials Vs of input/output terminals that are on the boundary of two blocks that adjoin each other, e.g., the terminal potential Vs(p) of the input/output terminal D(p) of a block having the block number “b”=1 and the terminal potential Vs(p+1) of the input/output terminal D(p+1) of a block having the block number “b”=2 are measured with the use of the same current source 161a(p), causing no gray-level discontinuity between these two terminal voltages.

In this manner, the present embodiment can prevent a gray-level discontinuity from occurring between the values to be measured from adjoining data lines that are on the boundary of connection switching.

Next, explanation will be given to an operation of the display device 1 during a luminescence operation in which the display device 1, to which an image signal Image is supplied from the outside, displays image information corresponding to the image signal on the TFT panel 11.

The display signal generating circuit 12 acquires display data Pic and a synchronization signal Sync from the supplied image signal Image and supplies them to the system controller 13. The system controller 13 stores the display data Pic supplied by the display signal generating circuit 12 in the correction data storage unit 131 in association with each pixel 11(i, j).

The system controller 13 controls the writing process, when the correction calculation unit 132 has stored voltage data Vdata, which are the display data Pic as corrected, in the correction data storage unit 131 for all the pixels 11(i, j).

When performing the writing process, the system controller 13 supplies the switch control signals Csw1(open) and Csw2(close) to the data driver 16, and the start signal Sp1 to the select driver 14.

The select driver 14 starts up as supplied with the start signal Sp1 by the system controller 13. In accordance with the clock signal CLK1 supplied by the system controller 13, the select driver 14 outputs a signal Vselect(j) of the Hi level to the pixels 11(1, 1) to 11(576, 1) of the first row, . . . , and the pixels 11(1, n) to 11(576, n) of the n-th row sequentially.

The switches Sw1(1) to Sw1(576) of the data driver 16 are opened as supplied with the switch control signal Csw1(open) by the system controller 13. In response, the input/output terminals D(1) to D(576) of the TFT panel 11 and the connection terminals P161(1) to P161(96) of the current source unit 161 are disconnected from each other.

The switches Sw2(1) to Sw2(576) are closed as supplied with the switch control signal Csw2(close) by the system controller 13. In response, the output terminals P164(1) to P164(576) of the data output unit 164 and the input/output terminals D(1) to D(576) are connected to each other.

When display data Pic is supplied by the display signal generating circuit 12 to the system controller 13, the correction calculation unit 132 of the system controller 13 reads out the threshold voltages Vth for the pixels (i, j). The calculation unit 132 corrects the display data Pic based on the read-out threshold voltages Vth. As having obtained voltage data Vdata, which are the display data Pic as corrected, the calculating unit 132 outputs them as Vdata(1) to Vdata(576) to the data driver 16 sequentially.

When supplied by the system controller 13 with the voltage data Vdata(1) to Vdata(576) for the first row, the data output unit 164 of the data driver 16 converts these voltage data Vdata(1) to Vdata(576) to analog voltage signals Sv(1) to Sv(576).

Then, the data output unit 164 outputs the voltage signals Sv(1) to Sv(576) obtained by conversion to the input/output terminals D(1) to D(576) of the TFT panel 11 via the switches Sw2(1) to Sw2(576) respectively.

Upon the select driver 14 outputting the signal Vselect(1) of the Hi level to the select line Ls(1) of the first row, voltages corresponding to the voltage signals Sv(1) to Sv(576) are written into the capacitors C1 of the pixels 11(1, 1) to 11(576, 1) of the first row.

Likewise, the data driver 16 writes voltages corresponding to voltage signals Sv(1) to Sv(576) into the capacitors C1 of the pixels 11(1, 2) to 11(576, 2) of the second row, . . . , and the pixels 11(1, n) to 11(576, n) of the n-th row. In which way, the writing process is completed.

When the writing process is completed, the system controller 13 controls the luminescence operation.

When performing the luminescence operation, first, the select driver 14 outputs signals Vselect(1) to Vselect(n) of the Lo level to the select lines Ls(1) to Ls(n) respectively.

When the signal level of the select lines Ls(1) to Ls(n) becomes the Lo level, the transistors T1 and T2 of all the pixels 11(i, j) are turned off.

Then, the system controller 13 supplies the voltage control signal Cv(H) to the power supply driver 15. As supplied with the voltage control signal Cv(H) by the system controller 13, the power supply driver 15 outputs signals Vsource(1) to Vsource(n) representing the voltage VH(=+15V) to the voltage lines Lv(1) to Lv(n).

When the voltage of the voltage lines Lv(1) to Lv(n) has become the voltage VH, the transistor T3 of each pixel (i, j) supplies a current corresponding to this voltage, which has been stored in the capacitor C1 as applied as the gate voltage Vgs of the transistor T3, to the organic EL element 111.

With this current flowing, each organic EL element 111 emits light at a luminance corresponding to the current value of this current.

As explained above, in accordance with the present embodiment, the switching unit 163 connects the input/output terminal D((b−1)×p+k) of the TFT panel 11 and the connection terminal P161(k) of the current source unit 161 to each other in a case where the block number “b” is odd. The switching unit 163 connects the input/output terminal D((b−1)×p+k) of the TFT panel 11 and the connection terminal P161(p−k+1) of the current source unit 161 to each other in a case where the block number “b” is even.

Therefore, even if deviation exists in the current values of the current sources 161a(1) to 161a(p) of the current source unit 161, it is possible to suppress gray-level discontinuity from occurring between the terminal potentials Vs measured from adjoining input/output terminals D(i) on the boundary of connection switching where the connection with the connection terminals P161(1) to P161(p) is switched from those in the block having an odd block number “b” to those in the block having an even block number “b” or vice versa, among the connection terminals D(1) to D(m). Therefore, it is possible to suppress degradation of the display quality.

Various embodiments (modifications) are available to carry out the present invention, which hence is not limited to the embodiment described above.

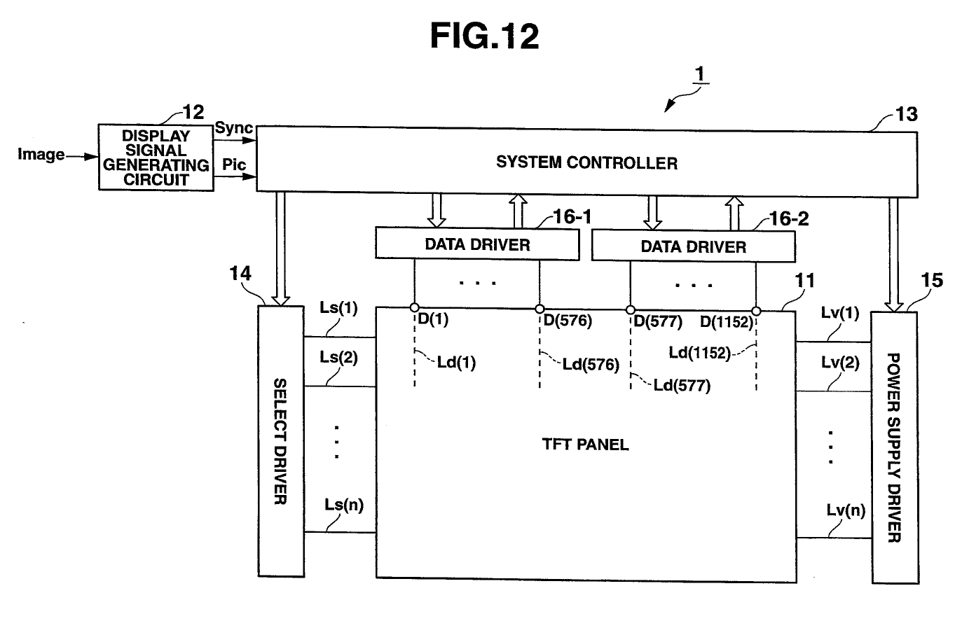

For example, in a case where the total number B of blocks is even, the data driver 16 may include two data drivers 16-1 and 16-2 as shown in FIG. 12.

In this case, the data drivers 16-1 and 16-2 are connected to the TFT panel 11. As long as both the data drivers 16-1 and 16-2 have the same characteristic and configuration, the potential voltages Vs corresponding to the connection terminals of the data drivers 16-1 and 16-2 that are at the boundary of the adjoining data drivers 16-1 and 16-2 will not have gray-level discontinuity.

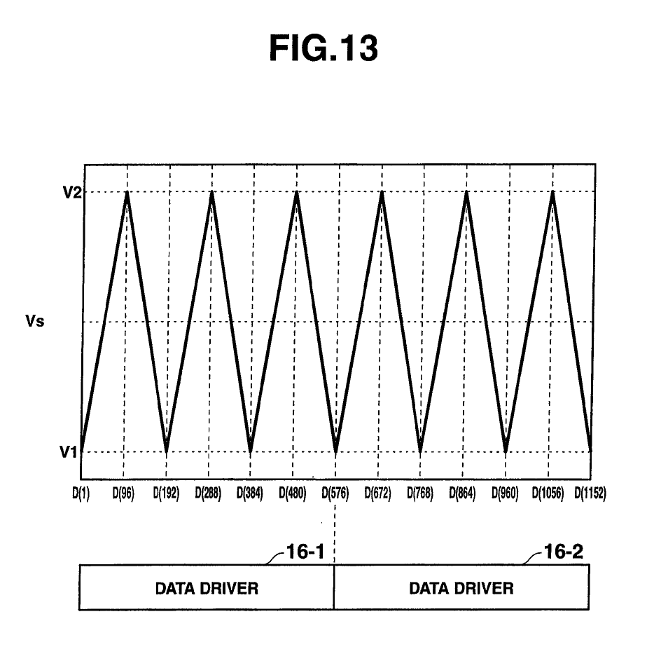

That is, assume a case where the switching unit 163 switches the normal order and the reverse order alternately block by block as described above, where m=576, p=96. If the total number B of blocks is even (here, B=6), the terminal potentials Vs(1) to Vs(1152) measured by the voltmeters 162v(1) to 162v(96) of the data drivers 16-1 and 16-2 will show the characteristic shown in FIG. 13. Hence, no gray-level discontinuity occurs between adjoining data drivers. FIG. 12 shows a case where there are two data drivers 16-1 and 16-2. However, there may exist three or more multiple data drivers.

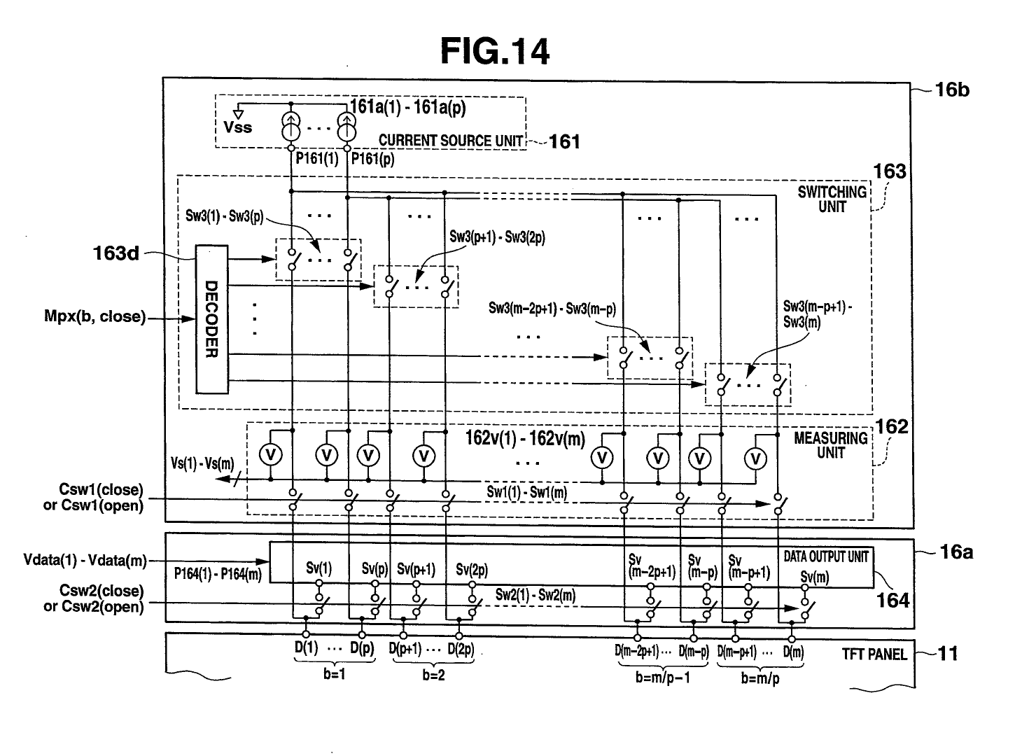

The display device 1 may include a data driver that is constituted by a data driver main unit 16a and a measuring unit 16b as shown in FIG. 14.

The data driver main unit 16a includes the data output unit 164. The measuring unit 16b includes the current source unit 161, the measuring unit 162, and the switching unit 163.

The data driver main unit 16a and the measuring unit 16b may be separately configured and mounted on different chips.

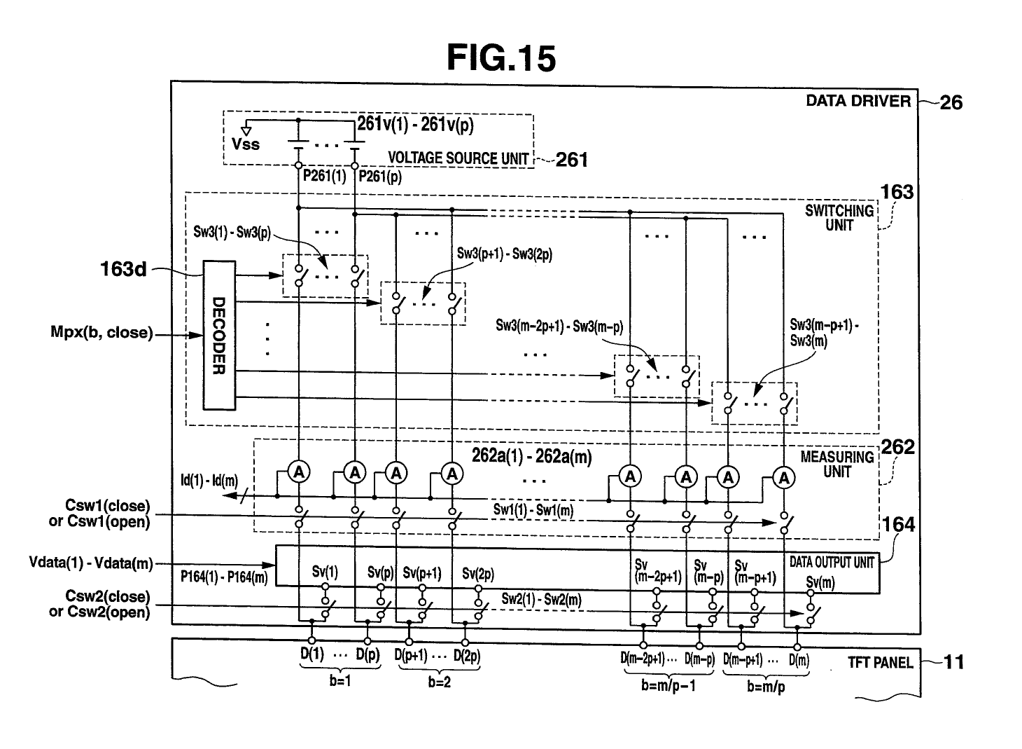

The embodiment described above has explained that the data driver 16 is configured in accordance with a current supply/voltage measurement method. However, the data driver 16 is not limited to this configuration, but may be configured in accordance with a voltage application/current measurement method as shown in FIG. 15.

The data driver 26 shown in FIG. 15 includes a voltage source unit 261, a measuring unit 262, a switching unit 163, switches Sw1(1) to Sw1(m) and Sw2(1) to Sw2(m), and the data output unit 164.

The voltage source unit 261 includes a plurality of voltage sources 261v(1) to 261v(p). The voltage sources 261v(1) to 261v(p) apply voltages to the data lines Ld(i). The voltage source unit 261 is a connection unit

The voltage source unit 261 includes a plurality of or “p” connection terminals P261(1) to P261(p). The negative terminals of the voltage sources 261v(1) to 261v(p) are connected to the connection terminals P261(1) to P261(p) respectively. A voltage Vss is applied to the positive terminals of the voltage sources 261v(1) to 261v(p). The voltage Vss is set to the same potential as the cathode voltage Vcath (=0V) of the organic EL element 111.

The measuring unit 262 includes “m” ammeters 262a(1) to 262a(m). The ammeters 262a(1) to 262a(m) measure the current values of currents Id that flow the data lines Ld(1) to Ld(m) respectively.

The ammeters 262a(1) to 262a(m) are interposed between the current-negative-side terminals of the switches Sw1(1) to Sw1(m) and the current-positive-side terminals of switches Sw3(1) to sw3(m) respectively, and output the current values of measured currents Id to the system controller 13.

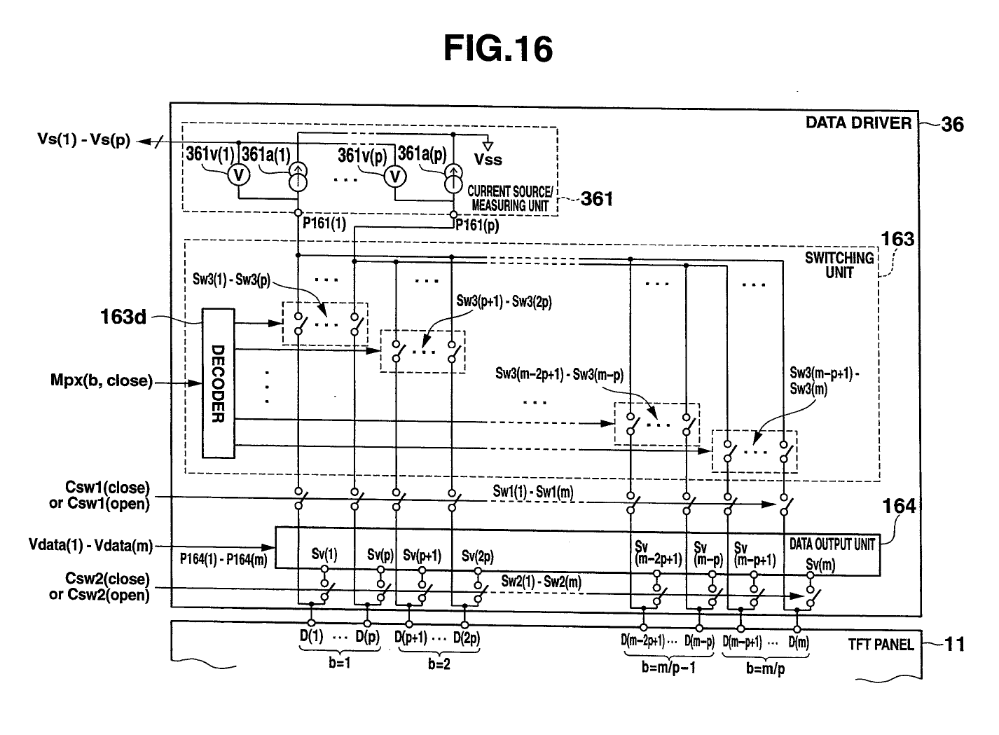

In the present embodiment, the data driver 16 may be replaced by a data driver 36 shown in FIG. 16, which includes a current source/measuring unit 361 instead of the current source unit 161.

The switching unit 163, the data output unit 164, and the switches Sw1(i) and Sw2(i) of the data driver 36 are identical with the switching unit 163, the data output unit 164, and the switches Sw1(i) and Sw2(i) shown in FIG. 4 respectively.

The current source/measuring unit 361 includes current sources 361a(1) to 361a(p) and voltmeters 361v(1) to 361v(p). That is, the current source/measuring unit 361 includes the voltmeters 361v(1) to 361v(p) in correspondence to the current sources 361a(1) to 361a(p) respectively. The number of current sources 361a(1) to 361a(p) and the number of voltmeters 361v(1) to 361v(p) are equal.

The current sources 361a(1) to 361a(p) are identical with the current sources 161a(1) to 161a(p) shown in FIG. 4.

The voltmeters 361v(1) to 361v(p) are identical with the voltmeters 162a(1) to 162a(m) shown in FIG. 4.

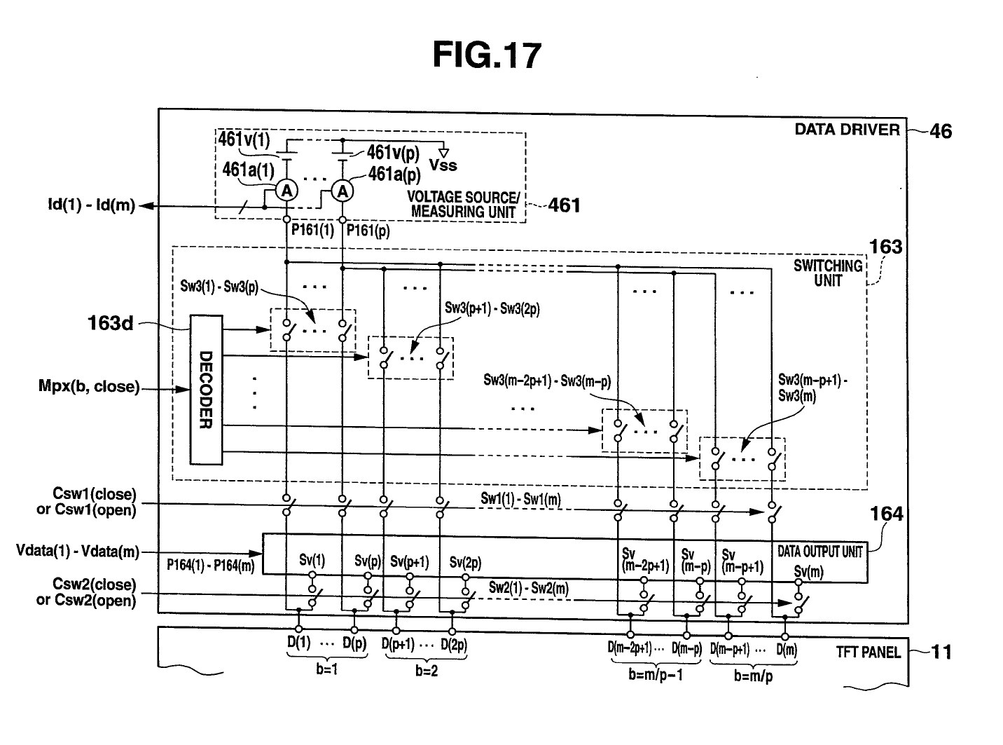

In the present embodiment, the data driver 16 may be replaced by a data driver 46 shown in FIG. 17, which includes a voltage source/measuring unit 461 instead of the current source unit 161.

The switching unit 163, the data output unit 164, and the switches Sw1(i) and Sw2(i) of the data driver 46 are identical with the switching unit 163, the data output unit 164, and the switches Sw1(i) and Sw2(i) shown in FIG. 4 respectively.

The voltage source/measuring unit 461 includes voltage sources 461v(1) to 461v(p) and ammeters 461a(1) to 461a(p). That is, the voltage source/measuring unit 461 includes the ammeters 461a(1) to 461a(p) in correspondence to the voltage sources 461v(1) to 461v(p) respectively. The number of voltage sources 461v(1) to 461v(p) is equal to the number of ammeters 461a(1) to 461a(p).

The voltage sources 461v(1) to 461v(p) are identical with the voltage sources 261v(1) to 261v(p) shown in FIG. 15 respectively.

The ammeters 461a(1) to 461a(p) are identical with the ammeters 262a(1) to 262a(m) shown in FIG. 15.

The embodiments described above have explained that deviation in the characteristics of the current sources 161a(1) to 161a(p) of the current source unit 161 or deviation in the characteristics of the voltage sources 261v(1) to 261v(p) of the voltage source unit 261 varies the voltage values to be measured by the respective voltmeters 162v(i) or the current values to be measured by the respective ammeters 262a(i).

However, even if the characteristics of the pixels, the current sources, or the voltage sources are even, if the characteristics of the voltmeters or the ammeters are uneven, the voltage values or current values to be measured by the respective voltmeters or the ammeters will show such a change as shown in FIG. 10(d).

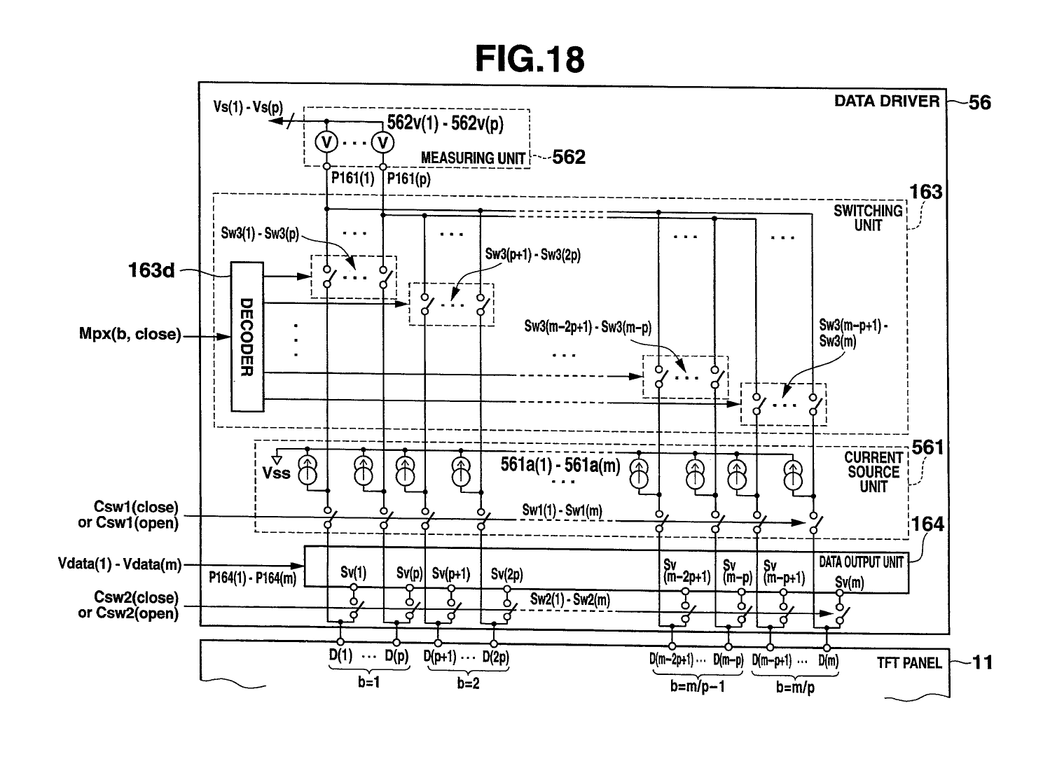

Hence, for example, the current source unit 161 of FIG. 4 may be replaced by a measuring unit, and the measuring unit 162 of FIG. 4 may be replaced by a current source unit. This configuration is shown in FIG. 18.

The data driver 56 shown in FIG. 18 includes a switching unit 163, switches Sw1(i) and Sw2(i), a data output unit 164, a current source unit 561, and a measuring unit 562.

The switching unit 163 and the data output unit 164 are identical with the switching unit 163 and the data output unit 164 shown in FIG. 4 respectively.

The current source unit 561 includes a plurality of or “m” current sources 561a(1) to 561a(m).

The measuring unit 562 includes a plurality of or “p” voltmeters 562v(1) to 562v(p).

The switching unit 163 connects the current sources and the voltmeters 562v(1) to 562v(p) of the measuring unit 562 by switching the connection order between the normal order and the reverse order alternately.

With this configuration, even if the characteristics of the voltmeters 562v(1) to 562v(p) are uneven, it is possible to prevent gray-level discontinuity from occurring in the voltage values to be measured from the input/output terminals D(1) to D(m) respectively.

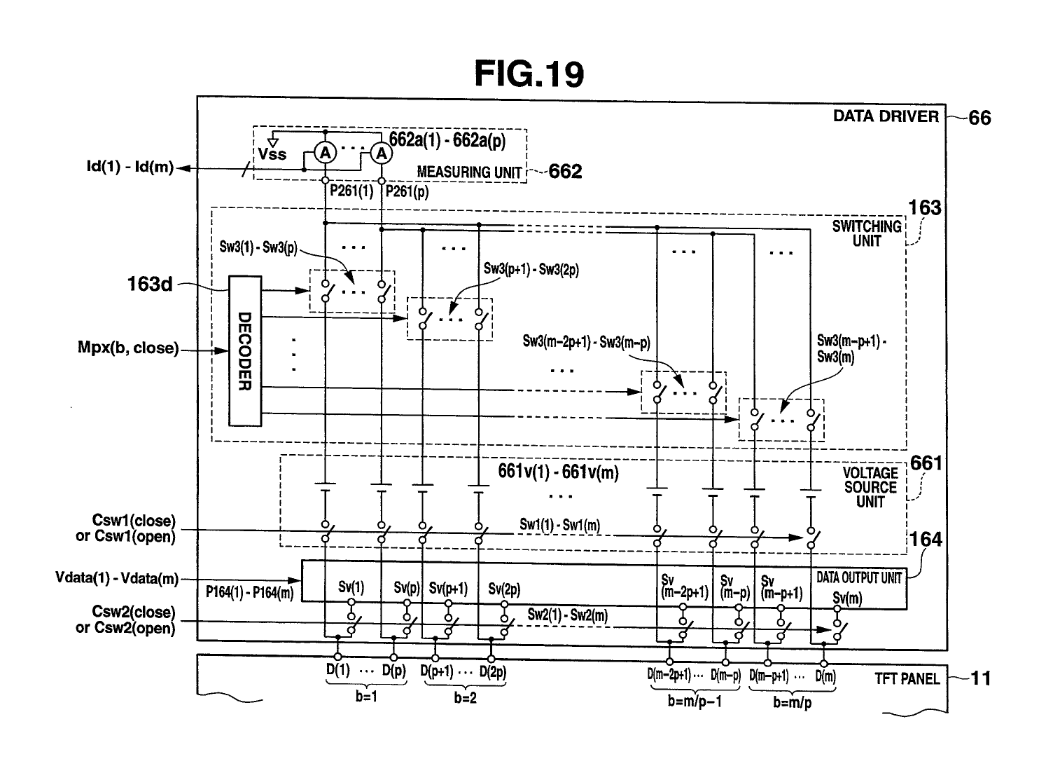

Alternatively, for example, the voltage source unit 261 shown in FIG. 15 may be replaced by a measuring unit, and the measuring unit 262 shown in FIG. 15 may be replaced by a voltage source unit. This configuration is shown in FIG. 19.

The data driver 66 shown in FIG. 19 includes a switching unit 163, switches Sw(i) and Sw2(i), a data output unit 164, a voltage source unit 661, and a measuring unit 662.

The switching unit 163 and the data output unit 164 are identical with the switching unit 163 and the data output unit 164 shown in FIG. 4 respectively.

The voltage source unit 661 includes a plurality or “m” voltage sources 661v(1) to 661v(m).

The measuring unit 662 includes a plurality of or “p” ammeters 662a(1) to 662a(p).

The switching unit 163 connects the ammeters 662a(1) to 662a(p) of the measuring unit 662 and the voltage sources 661v(1) to 661v(m) by switching the connection order between the normal order and the reverse order alternately.

With this configuration, even if the characteristics of the ammeters 662a(1) to 662a(p) are uneven, it is possible to prevent gray-level discontinuity from occurring in the current values to be measured from the input/output terminals D(1) to D(m) respectively.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2008-255550 filed on Sep. 30, 2008 and Japanese Patent Application No. 2009-046147 filed on Feb. 27, 2009 and including specification, claims, drawings and summary. The disclosure of the above Japanese Patent Application is incorporated herein by reference in its entirety.

What is claimed is:

1. A pixel drive device that drives a pixel array including a plurality of pixels connected to a plurality of input/output terminals, the pixel drive device comprising:
a connection unit that includes a plurality of connection terminals whose number is fewer than a number of the input/output terminals; and
a connection switching unit that switches connection between the connection terminals and the input/output terminals,
wherein the plurality of input/output terminals are divided into a plurality of blocks each including a predetermined number of input/output terminals,
the predetermined number is equal to or smaller than a number of the connection terminals, and
the connection switching unit switches connection between the connection terminals and the input/output terminals in a manner that the connection terminals and the input/output terminals of each of the blocks are connected sequentially, while setting a connection order, in which the input/output terminals of each block are connected to the connection terminals, such that adjoining two of the input/output terminals that belong to adjoining two of the blocks are connected to the same one of the plurality of connection terminals.

2. The pixel drive device according to claim 1,
wherein the predetermined number is set to be an even number into which a number of the plurality of input/output terminals can be divided.

3. The pixel drive device according to claim 1,
wherein the connection switching unit reverses the connection order in which the input/output terminals of one block are connected to the connection terminals, with respect to the connection order in which the input/output terminals of a block adjoining that block are connected to the connection terminals.

4. The pixel drive device according to claim 3,
wherein the connection switching unit includes:
a group of first switches that connect the connection terminals of the connection unit and the input/output terminals of each block assigned an odd ordinal number among the plurality of blocks in one connection order; and
a group of second switches that connect the connection terminals of the connection unit and the input/output terminals of each block assigned an even ordinal number among the plurality of blocks in an order reverse to the one connection order.

5. The pixel drive device according to claim 1,
wherein the connection unit includes a plurality of constant current sources correspondence to the plurality of connection terminals, wherein the constant current sources output currents having constant current values, and output terminals of the constant current sources are connected to the connection terminals respectively, and
the pixel drive device further includes a measuring unit that acquires values of potentials of the input/output terminals which the connection terminals of the connection unit are connected.

6. The pixel drive device according to claim 1,
wherein the connection unit includes a plurality of constant voltage sources correspondence to the plurality of connection terminals, wherein the constant voltage sources output voltages having constant voltage values, and output terminals of the constant voltage sources are connected to the connection terminals respectively, and
the pixel drive device further includes a measuring unit that acquires current values of currents that flow from the connection terminals of the connection unit to the input/output terminals via the connection switching unit.

7. The pixel drive device according to claim 1,
wherein the connection unit includes a measuring unit that includes a plurality of voltmeters which are provided correspondence to the plurality of connection terminals and whose input ends are connected to the connection terminals respectively, wherein the voltmeters acquire values of potentials of the connection terminals respectively.

8. The pixel drive device according to claim 1,
wherein the connection unit includes a measuring unit that includes a plurality of ammeters which are provided correspondence to the plurality of connection terminals and whose input ends are connected to the connection terminals respectively, wherein the ammeters acquire current values of currents that are supplied from the connection terminals to the input/output terminals.

9. A luminescence device, comprising:
a pixel array that includes a plurality of pixels connected to a plurality of input/output terminals and each including a luminescence element;
a connection unit that includes a plurality of connection terminals which are fewer than the plurality of input/output terminals; and
a connection switching unit that switches connection between the connection terminals and the input/output terminals,
wherein the plurality of input/output terminals are divided into a plurality of blocks each including a predetermined number of input/output terminals,
the predetermined number is equal to or smaller than a number of the connection terminals, and
the connection switching unit switches connection between the connection terminals and the input/output terminals in a manner that the connection terminals and the input/output terminals of each of the blocks are connected sequentially, while setting a connection order, in which the input/output terminals of each block are connected to the connection terminals, such that adjoining two of the input/output terminals that belong to adjoining two of the blocks are connected to the same one of the plurality of connection terminals.

10. The luminescence device according to claim 9,
wherein the predetermined number is set to be an even number into which a number of the plurality of input/output terminals can be divided.

11. The luminescence device according to claim 9,
wherein the connection switching unit reverses the connection order in which the input/output terminals of one block are connected to the connection terminals, with respect to the connection order in which the input/output terminals of a block adjoining that block are connected to the connection terminals.

12. The luminescence device according to claim 9,
wherein the connection unit includes a plurality of constant current sources correspondence to the plurality of connection terminals, wherein the constant current sources output currents having constant current values, and output terminals of the constant current sources are connected to the connection terminals respectively, and
the luminescence device further includes a measuring unit that acquires values of potentials of the input/output terminals of any block to which the connection terminals of the connection unit are connected.

13. The luminescence device according to claim 9,
wherein the connection unit includes a plurality of constant voltage sources correspondence to the plurality of connection terminals, wherein the constant voltage sources output voltages having constant voltage values, and output terminals of the constant voltage sources are connected to the connection terminals respectively, and
the luminescence device further includes a measuring unit that acquires current values of currents that flow from the connection terminals of the connection unit to the input/output terminals via the connection switching unit.

14. The luminescence device according to claim 9,
wherein the connection unit includes a measuring unit that includes a plurality of voltmeters which are provided correspondence to the plurality of connection terminals and whose input ends are connected to the connection terminals respectively, wherein the voltmeters acquire values of potentials of the connection terminals respectively.

15. The luminescence device according to claim 9,
wherein the connection unit includes a measuring unit that includes a plurality of ammeters which are provided correspondence to the plurality of connection terminals and whose input ends are connected to the connection terminals respectively, wherein the ammeters acquire current values of currents that are supplied from the connection terminals to the input/output terminals.

16. The luminescence device according to claim 9,
wherein the pixel array includes a plurality of data lines that are connected to the plurality of input/output terminals respectively, and each pixel includes a drive transistor, wherein one end of a current path of the drive transistor is connected to one end of the luminescence element and electrically connected to a corresponding one of the data lines, and a power supply voltage having a predetermined voltage value is applied to the other end of the current path, wherein the other end of the luminescence element is set at a constant potential.

17. A luminescence device, comprising:
a pixel array including “m” input/output terminals D(i) (where i=1 to m, where “m” is a natural number), and a plurality of pixels connected to the input/output terminals D(i) and each including a luminescence element;
a connection unit including “p” connection terminals P(k) (where k=1 to p, where “p” is a natural number and satisfies a relationship of p<m), and
a connection switching unit that connects any of the input/output terminals D(i) of the pixel array and the connection terminal P(k) of the connection unit to each other,
wherein the connection switching unit divides the input/output terminals D(i) of the pixel array into m/p blocks each including “p” input/output terminals out of the input/output terminals, and assigns a block number “b” to each divided block (where b=1 to m/p),
wherein the connection switching unit is configured such that when it connects the input/output terminal D((b−1)×p+k) of an odd number block whose block number “b” is odd and the connection terminal P(k) of the connection unit to each other, it connects the input/output terminal D((b−1)×p+k) of an even number block whose block number “b” is even and the connection terminal P(p−k+1) of the connection unit to each other, and
the connection switching unit is configured such that when it connects the input/output terminal D((b−1)×p+k) of an even number block whose block number “b” is even and the connection terminal P(k) of the connection unit to each other, it connects the input/output terminal D((b−1)×p+k) of an odd number block whose block number “b” is odd and the connection terminal P(p−k+1) of the connection unit to each other.

18. The luminescence device according to claim 17, comprising a control unit that supplies the connection switching unit with a switch control signal for switching the input/output terminals D(i) to be connected to the connection unit from those of an odd number block to those of an even number block or vice versa,
wherein the connection switching unit includes:
a first switch whose one end is connected to the input/output terminal D((b−1)×p+k) of an odd number block and whose other end is connected to the connection terminal P(k) of the connection unit;
a second switch whose one end is connected to the input/output terminal D((b−1)×p+k) of an even number block and whose other end is connected to the connection terminal P(p−k+1) of the connection unit; and
an opening/closing control unit that controls opening/closing of the first switch and the second switch in accordance with the switch control signal supplied by the control unit.

19. The luminescence device according to claim 17, comprising a control unit that supplies the connection switching unit with a switch control signal for switching the input/output terminals D(i) to be connected to the connection unit from those of an odd number block to those of an even number block or vice versa,
wherein the connection switching unit includes:
a first switch whose one end is connected to the input/output terminal D((b−1)×p+k) of an even number block and whose other end is connected to the connection terminal P(k) of the connection unit;
a second switch whose one end is connected to the input/output terminal D((b−1)×p+k) of an odd number block and whose other end is connected to the connection terminal P(p−k+1) of the connection unit; and
an opening/closing unit that controls opening/closing of the first switch and the second switch in accordance with the switch control signal supplied by the control unit.

20. A method of connecting a connection unit to a pixel array of a pixel drive device that drives the pixel array, the pixel array including a plurality of pixels connected to a plurality of input/output terminals,
the connection unit including a plurality of connection terminals whose number is fewer than a number of the input/output terminals,
the method comprising
dividing the plurality of input/output terminals into a plurality of blocks each including a predetermined number of input/output terminals, the predetermined number being equal to or smaller than a number of the connection terminals, and performing a switching operation of sequentially switching connection between the connection terminals of the connection unit and the input/output terminals of each of the blocks,
wherein the switching operation includes:
when connecting the connection terminals and the input/output terminals of one of two adjoining blocks, connecting a specific one of the plurality of connection terminals to one of two adjoining input/output terminals belonging to one of the two adjoining blocks; and
when connecting the connection terminals and the input/output terminals of the other of the two adjoining blocks, connecting the specific connection terminal to the other of the two adjoining input/output terminals belonging to the other of the two adjoining blocks.
